(19) United States
(12) Patent Application Publication
(10) Pub. No.: US 2026/0301610 A1
(43) Pub. Date: Oct. 1, 2026

(54) ELECTRONIC SHELF LABEL COMPRISING SEALING MEMBER

(71) Applicant: Solum Co., Ltd., Yongin-si, Gyeonggi-do (KR)

(72) Inventor: Seo Jin Lee, Yongin-si (KR)

(21) Appl. No.: 19/475,970

(22) PCT Filed: Apr. 17, 2024
(86) PCT No.: PCT/KR2024/005135

§ 371 Date: Oct. 16, 2025

(30) Foreign Application Priority Data
Apr. 19, 2023 (KR) 10-2023-0051516
Apr. 19, 2023 (KR) 10-2023-0051526

(51) Int. Cl. G09F 3/20

(52) U.S. Cl. CPC G09F 3/208

(57) ABSTRACT

One embodiment provides an electronic shelf label comprising: a window; a main case coupled to the rear of the window; a display module provided in a first internal space formed between the rear of the window and the main case and displaying product information; a printed circuit board provided in the first internal space to be electrically connected to the display module; a rear cover coupled to the rear of the main case, a battery provided in a second internal space formed between the main case and the rear cover; and a sealing member provided on a side of the rear cover.

### TECHNICAL FIELD

The present disclosure relates to an electronic shelf label including a sealing member.

### BACKGROUND ART

Electronic labels are increasingly being used in applications such as displaying product information on products displayed in stores. Electronic labels, also known as electronic shelf labels or electronic tags, are connected to a server via a gateway, receive product information, and display the received product information on an electronic paper display. Electronic paper displays are increasingly being used due to their low-power operation, which allows for extended battery life, and the ability to change display information via a communications network, which reduces store management labor costs.

When a new product is placed on a shelf, a process is required to assign the new product to an electronic shelf label such that the electronic shelf label displays the information on the new product. Typically, a store manager reads a barcode attached to an electronic label with a terminal, then reads the product barcode and transmits the same to a server. The server then assigns the electronic shelf label to the product, registers the same in a database, and transmits relevant information about the product to the electronic shelf label to change the display.

An electronic shelf label includes a display module that displays product information, a printed circuit board (PCB) containing an IC chip that drives the display module, a battery that supplies power to the PCB, and a housing for protecting these key components. The housing may include a transparent window covering the display module and a main case that is combined with the window to form an internal space for housing the display module, the PCB, and the battery.

The internal components, such as the PCB and the display module, disposed within the electronic shelf label are vulnerable to moisture, and thus the internal space of the electronic shelf label needs to be protected from moisture generated by various sources, such as beverage bottles and water cups, near store shelves.

Meanwhile, countless products may be displayed on store shelves. To encourage purchases of multiple products, advertising content for each product can be provided to store customers. Typically, advertising content for products can be delivered through various channels, such as TV commercials and social media ads. However, this one-sided advertising provision method has limitations in allowing store customers to access real-time advertising content for products they wish to purchase on-site.

### DISCLOSURE

### Technical Problem

Various embodiments of the present disclosure provide an electronic shelf label including a sealing member provided at an appropriate position to enhance waterproofing.

Various embodiments of the present disclosure provide an electronic shelf label including a sealing member having improved durability and a slim design.

Various embodiments of the present disclosure provide an electronic shelf label and a method of manufacturing the electronic shelf label for improving esthetics by enhancing the structural integrity of the front surface on which product-related information is displayed.

Various embodiments of the present disclosure provide an electronic shelf label and a method of manufacturing the electronic shelf label for improving esthetics and simultaneously enhancing overall structural stability.

Various embodiments of the present disclosure provide a method of providing content related to a product assigned to an electronic shelf label based on user input via a button on the electronic shelf label.

Various embodiments of the present disclosure provide a method of providing product-related content, which displays content related to a product assigned to an electronic shelf label on a display module of the electronic shelf label or an external electronic device based on user input via a button on the electronic shelf label.

### Technical Solution

One embodiment provides
an electronic shelf label including a window, a main case coupled to a rear surface of the window, a display module provided in a first internal space formed between the rear surface of the window and the main case to display product information, a printed circuit board provided in the first internal space and electrically connected to the display module, a rear cover coupled to a rear surface of the main case, a battery provided in a second internal space formed between the main case and the rear cover, and a sealing member provided on a side surface of the rear cover.

In another aspect, the rear cover may include a protrusion coupled to the main case, and the sealing member may be provided on an outer side surface of the protrusion.

In another aspect, a sealing groove may be formed on an outer side surface of the protrusion of the rear cover, and the sealing member may be provided in the sealing groove.

In another aspect, the sealing member may have a closed loop shape surrounding the side surface of the rear cover.

In another aspect, the sealing member may contact an inner surface of the main case.

In another aspect, an end of the protrusion of the rear cover may have a hook shape.

In another aspect, the hook-shaped end may face the battery.

In another aspect, the main case may include a flat plate, a first protrusion protruding upward from an edge region of an upper surface of the plate, and a second protrusion protruding downward from an edge region of a lower surface of the plate.

In another aspect, the first protrusion may contact an edge region of a lower surface of the window.

In another aspect, the rear cover may be provided to be surrounded by an inner surface of the second protrusion.

In another aspect, the rear cover may include a third protrusion surrounded by the second protrusion and coupled to the main case.

In another aspect, a first sub-protrusion may be formed on an inner surface of the second protrusion, and a second sub-protrusion supported by the first sub-protrusion may be formed on an outer side surface of the third protrusion.

In another aspect, a fourth protrusion may be formed to protrude downward in a portion of the plate, an end of the third protrusion may have a first hook shape, and an end of the fourth protrusion may have a second hook shape formed to engage with the first hook shape.

In another aspect, the lower surface of the rear cover and the lower surface of the second protrusion may be disposed on the same line.

In another aspect, a step may be formed on an edge region of an upper surface of the main case, and the bonding member may be provided on the step.

In another aspect, the window may cover the entire front surface of the main case.

### Advantageous Effects

According to various embodiments of the present disclosure, it is possible to provide an electronic shelf label including a sealing member provided on the side of a rear cover coupled to the rear of a main case to enhance waterproofing.

According to various embodiments of the present disclosure, it is possible to provide an electronic shelf label including a sealing member with enhanced durability and a slim design by providing a display module and a printed circuit board in a first internal space separated from a second internal space by the main case and providing a battery in the second internal space.

According to various embodiments of the present disclosure, it is possible to provide an electronic shelf label and a method of manufacturing the electronic shelf label to enhance the esthetics by allowing a window covering the display module to cover the entire front of the main case, thereby enhancing the structural integrity of the front surface on which product-related information is displayed.

According to various embodiments of the present disclosure, it is possible to provide an electronic shelf label and a method of manufacturing the electronic shelf label to enhance the esthetics and overall structural stability by allowing the window to cover the entire front of the main case, thereby eliminating a bezel surrounding the side of the window and allowing a rear cover to be surrounded by the inner surface of the main case.

According to various embodiments of the present disclosure, it is possible to provide a method of providing content related to a product assigned to an electronic shelf label based on user input via a button on the electronic shelf label.

According to various embodiments of the present disclosure, it is possible to provide a method of providing product-related content for displaying content related to a product assigned to an electronic shelf label on a display module of the electronic shelf label or an external electronic device based on user input via a button on the electronic shelf label.

According to various embodiments of the present disclosure, it is possible to provide a method of providing product-related content for allowing a store customer to obtain content related to a product the customer wishes to purchase in real time by manipulating a button on an electronic shelf label assigned to the product.

### DESCRIPTION OF DRAWINGS

FIG. 1 illustrates an exemplary configuration of an electronic shelf label system that displays product-related information according to an embodiment.

FIG. 2 is a block diagram illustrating an exemplary configuration of a server according to an embodiment.

FIG. 3 is a block diagram illustrating an exemplary configuration of a computing device according to an embodiment.

FIG. 4 is a front view illustrating an exemplary configuration of an electronic shelf label according to an embodiment.

FIG. 5 is a side view illustrating an exemplary configuration of the electronic shelf label according to an embodiment.

FIG. 6 is a rear view illustrating an exemplary configuration of the electronic shelf label according to an embodiment.

FIG. 7 is an exploded view illustrating an exemplary configuration of the electronic shelf label according to an embodiment.

FIG. 8 illustrates an exemplary internal configuration of the electronic shelf label according to an embodiment.

FIG. 9 illustrates an exemplary configuration of an electronic shelf label according to another embodiment.

FIG. 10 illustrates an exemplary configuration of an electronic shelf label according to another embodiment.

FIG. 11 illustrates an exemplary configuration of an electronic shelf label according to another embodiment.

FIG. 12 illustrates a bonding state between a window and a main case of an electronic shelf label according to another embodiment.

FIG. 13 illustrates a bonding state between a window and a main case of an electronic shelf label according to another embodiment.

FIG. 14 illustrates a bonding state between a window and a main case of an electronic shelf label according to another embodiment.

FIG. 15 is a flowchart of a method of manufacturing an electronic shelf label according to an embodiment.

FIG. 16 illustrates a method of aligning the window and the main case of the electronic shelf label according to an embodiment.

FIG. 17 is a flowchart of a method of manufacturing an electronic shelf label according to another embodiment.

FIG. 18 illustrates an exemplary configuration of a product-related content provision system according to an embodiment.

FIG. 19 is a block diagram illustrating an exemplary configuration of an electronic shelf label according to an embodiment.

FIG. 20 is a front view illustrating an exemplary configuration of the electronic shelf label of FIG. 19.

FIG. 21 illustrates an exemplary configuration of the bottom surface of the electronic shelf label of FIG. 19.

FIG. 22 is a block diagram illustrating an exemplary configuration of a server according to an embodiment.

FIG. 23 is a block diagram illustrating an exemplary configuration of a computing device according to an embodiment.

FIG. 24 is a flowchart illustrating a method of providing product-related content according to an embodiment.

FIG. 25 illustrates product-related content displayed on an electronic shelf label according to an embodiment.

FIG. 26 illustrates product-related content displayed on an electronic shelf label according to another embodiment.

FIG. 27 illustrates product-related content displayed on an electronic shelf label according to another embodiment.

FIG. 28 is a flowchart illustrating a step of displaying product-related content on a display module according to an embodiment.

FIG. 29 illustrates product-related content displayed on a computing device according to an embodiment.

FIG. 30 is a flowchart illustrating a method of providing product-related content according to another embodiment.

### MODE FOR INVENTION

The present disclosure is capable of various modifications and embodiments. Therefore, specific embodiments are illustrated in the drawings and described in detail in the detailed description. The effects and features of the present disclosure, and the methods for achieving the same will become clearer with reference to the embodiments described in detail below together with the drawings. However, the present disclosure is not limited to the embodiments disclosed below and can be implemented in various forms. In the following embodiments, terms such as “first” and “second” are not used in a limiting sense but are used for the purpose of distinguishing one component from another. Furthermore, the singular expression includes plural expressions unless the context clearly indicates otherwise. Furthermore, terms such as “include” and “comprise” indicate the presence of a feature or a component described in the specification, and do not preemptively exclude the possibility of one or more other features or components being added. Furthermore, the sizes of components in the drawings may be exaggerated or reduced for convenience of description. For example, the size and thickness of each component shown in the drawings are arbitrarily shown for convenience of description, and thus the present disclosure is not necessarily limited to what is shown.

Hereinafter, embodiments of the present disclosure will be described in detail with reference to the attached drawings. When describing with reference to the drawings, identical or corresponding components are given the same reference numerals and redundant descriptions thereof will be omitted.

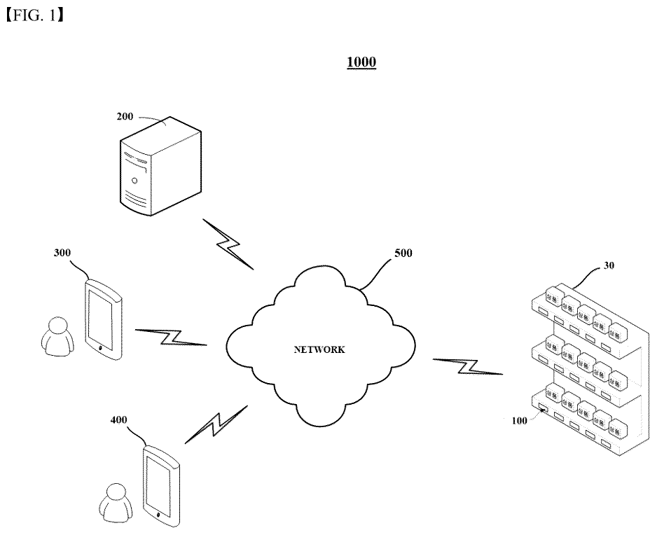

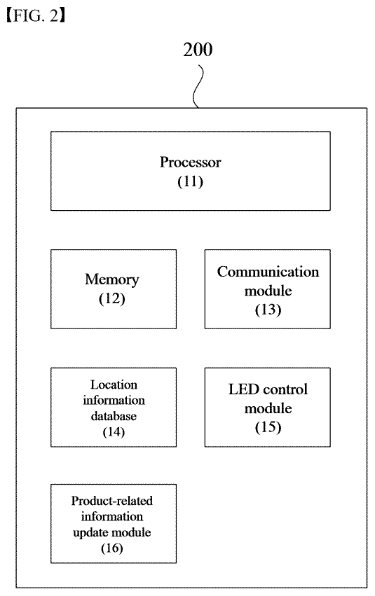

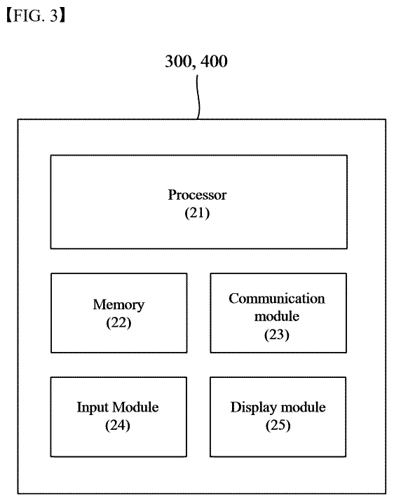

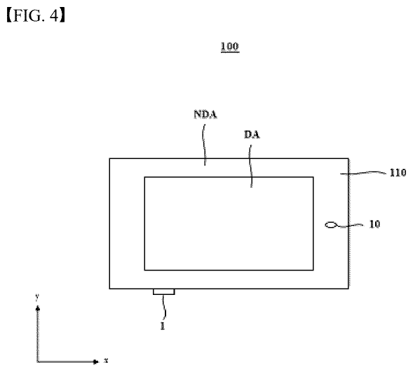

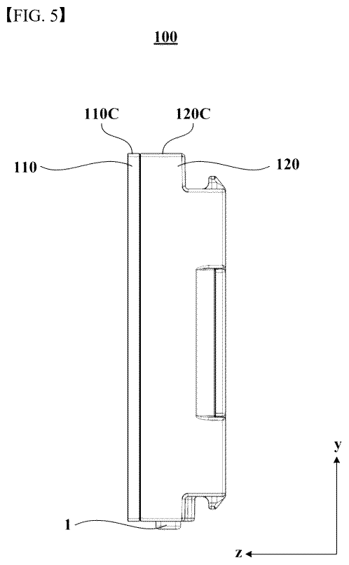

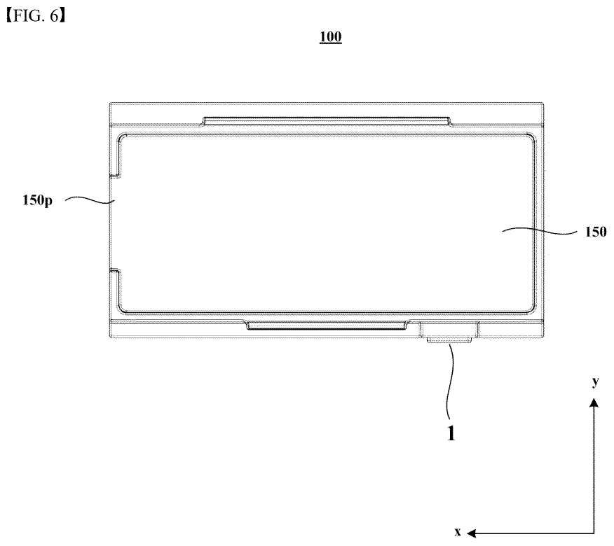

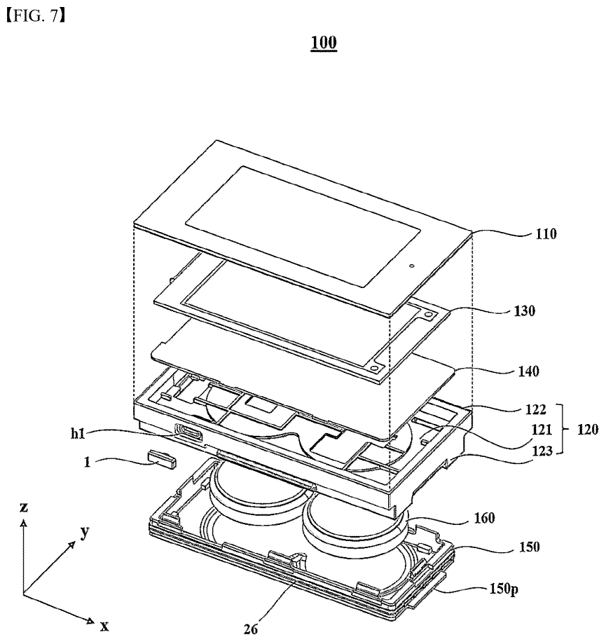

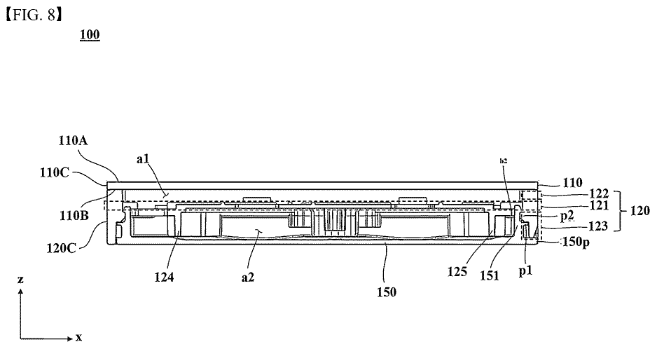

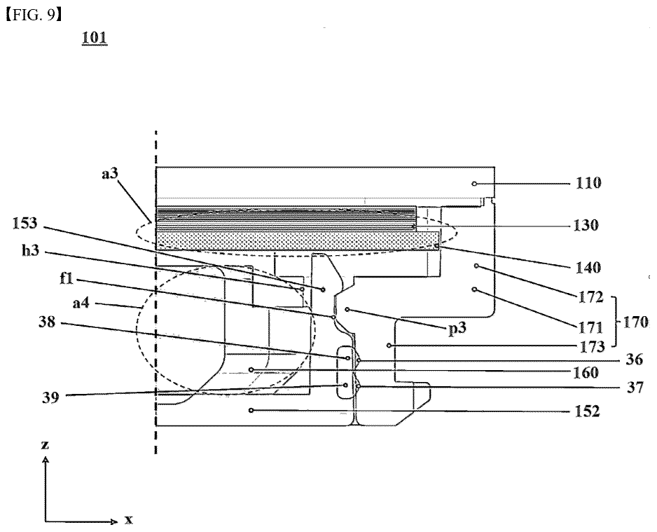

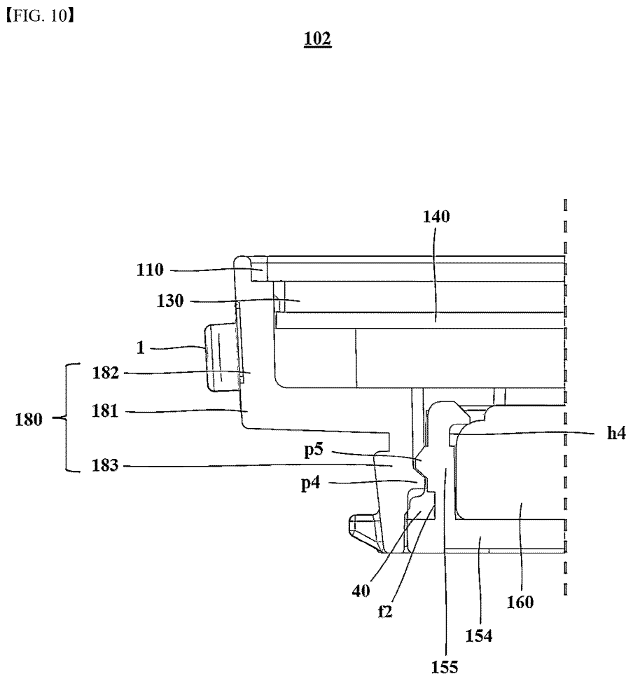

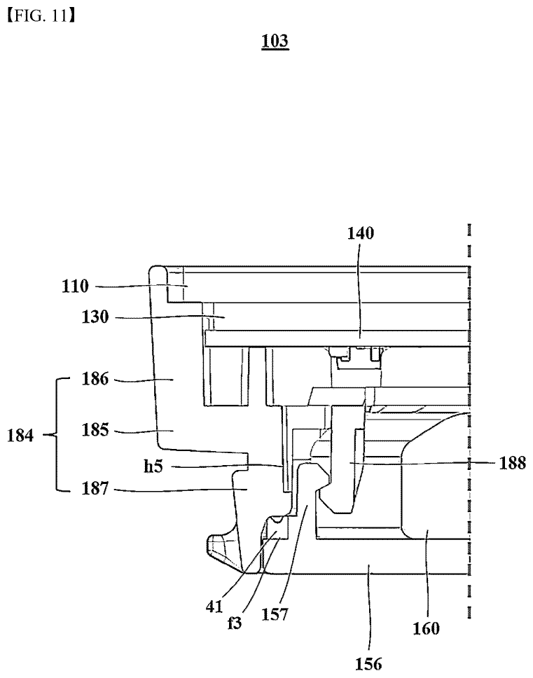

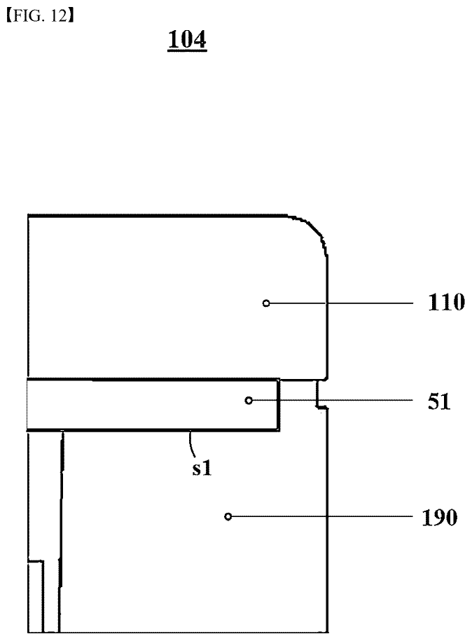

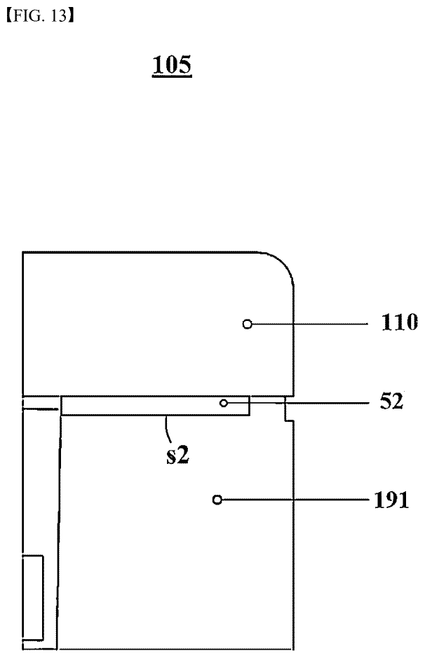

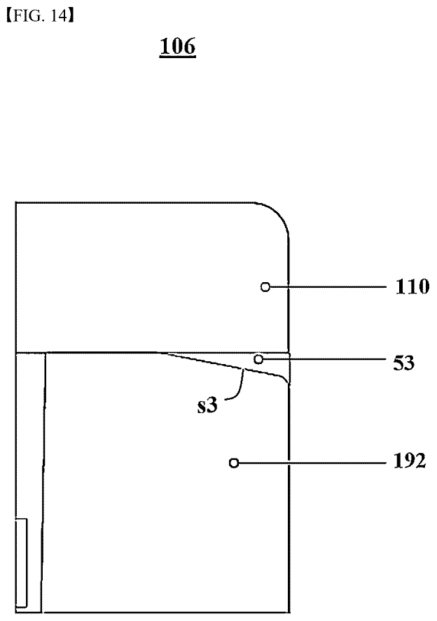

FIG. 1 illustrates an exemplary configuration of an electronic shelf label system 1000 that displays product-related information according to an embodiment. FIG. 2 is a block diagram illustrating an exemplary configuration of a server 200 according to an embodiment. FIG. 3 is a block diagram illustrating an exemplary configuration of a computing device 300 and 400 according to an embodiment. FIG. 4 is a front view illustrating an exemplary configuration of an electronic shelf label 100 according to an embodiment. FIG. 5 is a side view illustrating an exemplary configuration of the electronic shelf label 100 according to an embodiment. FIG. 6 is a rear view illustrating an exemplary configuration of the electronic shelf label 100 according to an embodiment. FIG. 7 is an exploded view illustrating an exemplary configuration of the electronic shelf label 100 according to an embodiment. FIG. 8 illustrates an exemplary internal configuration of the electronic shelf label 100 according to an embodiment. FIG. 9 illustrates an exemplary configuration of an electronic shelf label 101 according to another embodiment. FIG. 10 illustrates an exemplary configuration of an electronic shelf label 102 according to another embodiment. FIG. 11 illustrates an exemplary configuration of an electronic shelf label 103 according to another embodiment. FIG. 12 illustrates a state of connection between a window 110 and a main case 190 of an electronic shelf label 104 according to another embodiment. FIG. 13 illustrates a state of connection between a window 110 and a main case 191 of an electronic shelf label 105 according to another embodiment. FIG. 14 illustrates a state of connection between a window 110 and a main case 192 of an electronic shelf label 106 according to another embodiment.

### -System 1000

Referring to FIG. 1, the system 1000 may include an electronic shelf label 100 provided on a shelf 30, a server 200, and computing devices 300 and 400. The computing devices 300 and 400 may include portable user terminals.

The electronic shelf label 100 included in the system 1000 may be linked to the server 200, and product-related information displayed on the electronic shelf label 100 may be updated by the server 200. Data regarding the updated product-related information is transmitted from the server 200 to the electronic shelf label 100, and the electronic shelf label 100 may display the updated product-related information. In this case, the server 200 may update product-related information based on user input via the computing devices 300 and 400.

For example, the shelf 30 may be provided with a plurality of electronic shelf labels 100 and a plurality of products. Each product may be assigned to each electronic shelf label 100. A first product may be assigned to any first electronic shelf label among the plurality of electronic shelf labels 100, and a second product different from the first product may be assigned to any second electronic shelf label. The first electronic shelf label and the first product may be provided adjacent to each other, and the second electronic shelf label and the second product may be provided adjacent to each other.

The server 200 may update information related to the products assigned to the electronic shelf labels 100. The server 200 may collectively update the information related to the products and transmit the updated information related to the products to the electronic shelf labels 100. For example, the server 200 may update information related to any first product among the plurality of products and transmit the updated information related to the first product to the first electronic shelf label to which the first product is assigned. Furthermore, the server 200 may update information related to any second product among the plurality of products and transmit the updated information related to the second product to the second electronic shelf label to which the second product is assigned.

The electronic shelf label 100, the server 200, and the computing devices 300 and 400 may be connected to each other through a network 500. Here, the network 500 according to the embodiment may refer to a connection structure that enables information exchange between nodes, such as the electronic shelf label 100, the server 200, and the computing devices 300 and 400. For example, the network 500 may include, but is not limited to, a 3rd Generation Partnership Project (3GPP) network, a Long Term Evolution (LTE) network, a World Interoperability for Microwave Access (WIMAX) network, the Internet, a local area network (LAN), a wireless LAN, a wide area network (WAN), a personal area network (PAN), a Bluetooth network, a satellite broadcasting network, an analog broadcasting network, a digital multimedia broadcasting (DMB) network, etc.

The electronic shelf label 100 may be wirelessly connected to the server 200 via a separate gateway (not shown). However, the present disclosure is not limited thereto, and the electronic shelf label 100 may be connected to the computing devices 300 and 400 via wireless communication. For example, the electronic shelf label 100 may be paired to the computing devices 300 and 400 based on the Bluetooth function.

The electronic shelf label 100 may be an electronic device mounted on the shelf 30 to display information related to a product displayed on the shelf 30. For example, the electronic shelf label 100 may display product-related information such as a Korean product name, an English product name, a country of origin, a product price, raw materials, and weight/calories.

The electronic shelf label 100 may include an electronic paper display (EPD), which maintains a product information display state even when power is not supplied. Due to bistability, which allows the electronic paper display to maintain the display state for a long period of time even when power is interrupted, the electronic paper display is suitable for the electronic shelf label 100 that requires reduced power consumption. Known electronic paper displays include a twist ball type using a hemispherical twist ball charged with electrostatic charge, an electrophoretic display utilizing electrophoresis and microcapsules, a cholesterol liquid crystal display using cholesterol liquid crystals, etc.

However, the present disclosure is not limited thereto, and the electronic shelf label 100 may include any one of a liquid crystal display (LCD), a thin film transistor-liquid crystal display (TFT LCD), an organic light-emitting diode (OLED), a flexible display, and a 3D display.

The server 200 may update information related to a product assigned to the electronic shelf label 100 provided on the shelf 30 and transmit the updated product-related information to the electronic shelf label 100. In this case, the server 200 may update the product-related information based on user input received via the computing devices 300 and 400.

Specifically, to update information related to the product assigned to the electronic shelf label 100, the server 200 may exchange necessary data with the electronic shelf label 100 and the computing device 300 or 400. Accordingly, the server 200 may provide an environment necessary for updating the product-related information.

For example, the server 200 may provide an environment in which product-related information can be updated using the computing devices 300 and 400 (e.g., a portable user terminal type computing device, a desktop type computing device, etc.). The server 200 may include an application program, data and/or instructions for operating a product-related information update application, and may transmit data based thereon to the computing devices 300 and 400.

Additionally, the server 200 may provide a license key to the computing devices 300 and 400. The server 200 may provide an editing license key for granting the computing devices 300 and 400 the authority to update product-related information. For example, customers or employees of a store may receive a product-related information update service by using the computing devices 300 and 400 that has received the editing license key.

Referring to FIG. 2, the server 200 may be implemented as a computing device that includes at least one processor 11 for data processing, a memory 12 storing application programs, data, and/or instructions, at least one communication module 13 for data exchange with external devices, a location information database 14 storing location information of the electronic shelf label 100, an LED control module 15 for controlling the operation of an LED 10 of the electronic shelf label 100, and a product-related information update module 16 for updating product-related information.

The processor 11 may control the overall operation of components included in the server 200 to provide an environment in which a product-related information update application can operate on the computing devices 300 and 400.

The processor 11 may be a system-on-chip (SOC) including a central processing unit (CPU) and/or a graphics processing unit (GPU), and may execute an operating system (OS) and/or application programs stored in the memory 12.

In addition, the processor 11 may internally communicate with each component included in the server 200 via a system bus, and may include one or more predetermined bus structures, including a local bus.

Additionally, the processor 11 may be implemented using at least one of application specific integrated circuits (ASICs), digital signal processors (DSPs), digital signal processing devices (DSPDs), programmable logic devices (PLDs), field programmable gate arrays (FPGAs), controllers, microcontrollers, microprocessors, and other electrical units for performing functions.

The memory 12 may store one or more of an operating system (OS), various application programs, data, and instructions for providing an environment necessary to perform a method of updating product-related information.

Furthermore, the memory 12 may include a program area and a data area. Here, the program area according to an embodiment may be linked between the operating system (OS) that boots the server 200 and functional elements, and data generated according to the use of the server 200 may be stored in the data area.

In an embodiment, the memory 12 may be various storage devices such as a ROM, a RAM, an EPROM, a flash drive, and a hard drive or may be a web storage that performs a storage function over the Internet. Furthermore, the memory 12 may be a storage medium that is removable from the server 200.

The communication module 13 may include various types of communication devices that enable the server 200 to transmit/receive data to/from external devices. The server 200 can transmit data based on an application program, data, and/or instructions for the product-related information update application to the computing devices 300 and 400 via the communication module 13.

The location information database 14 may store location information of the electronic shelf label 100. A plurality of electronic shelf labels 100 can be provided on the shelf 30 to correspond to a plurality of products. These electronic shelf labels 100 can be placed at specific locations on the shelf 30, and specific location information of the plurality of electronic shelf labels 100 with respect to the shelf 30 can be stored in the location information database 14.

For example, among the plurality of electronic shelf labels 100, a first electronic shelf label may be provided on the second row, third column of the first shelf provided in zone A among a plurality of zones. In this case, the location information of the first electronic shelf label, “the second row, third column of the first shelf in zone A,” may be stored in the location information database 14 as the location information of the first electronic shelf label in association with unique identification number of the first electronic shelf label.

The LED control module 15 may control lighting of the LED included in the electronic shelf label 100 based on a signal from the computing devices 300 and 400. For example, a first user input for selecting a first product among a plurality of products may be received by the computing device 300 or 400). Based on the first user input, a first signal may be transmitted from the computing device 300 or 400 to the server 200. The server 200 may receive the first signal via the communication module 13, and the first signal may be transmitted to the LED control module 15. The LED control module 15 may control the operation of the first LED of the first electronic shelf label such that the first LED of the first electronic shelf label to which the first product is assigned turns on based on the first signal.

The product-related information update module 16 may update product-related information displayed on the electronic shelf label 100. For example, the product-related information update module 16 may control the electronic shelf label 100 such that product-related information displayed on the electronic shelf label 100 is periodically updated according to a product-related information update rule stored in the memory 12. The product-related information update rule stored in the memory 12 may be preset by the user and constantly modified.

However, the present disclosure is not limited thereto, and the product-related information update module 16 may also control the electronic shelf label 100 such that product-related information displayed on the electronic shelf label 100 is updated according to user input for editing the product-related information.

In the above description, the server 200 according to an embodiment performs the functional operations as described above. However, at least some functional operations performed by the server 200 may be performed by an external device (e.g., the computing devices 300 and 400), and at least some functional operations performed by the external device may be further performed by the server 200 according to various embodiments.

The computing devices 300 and 400 may be devices in which the product-related information update application is installed. The computing devices 300 and 400 may include a portable user terminal. The computing devices 300 and 400 may be divided into a first computing device 300 and a second computing device 400 according to the user.

For example, the user of the first computing device 300 may be a store employee, and the user of the second computing device 400 may be a store customer. The first computing device 300 and the second computing device 400 may have substantially the same structure.

The computing devices 300 and 400 may be implemented as, for example, a computer or a portable terminal that can connect to the server 200 via a network 500. Here, the computer may include, for example, a notebook, desktop, laptop equipped and a VR HMD (for example, HTC VIVE, Oculus Rift, GearVR, DayDream, PSVR, etc.) with a web browser, etc. Here, the VR HMD includes all of VR HMD for PCs (for example, HTC VIVE, Oculus Rift, FOVE, Deepon, etc.), VR HMD for mobiles (for example, GearVR, DayDream, Storm Magic, Google Cardboard, etc.), and stand-alone models (for example, Deepon, PICO, etc.) implemented independently of VR HMD for consoles (for example, PSVR). The portable terminal is, for example, a wireless communication device that ensures portability and mobility, and may include various devices equipped with communication modules such as Bluetooth (Bluetooth Low Energy (BLE)), NFC, RFID, ultrasonic, infrared, Wi-Fi, and Li-Fi, as well as a smartphone, a tablet, and a wearable device.

Referring to FIG. 3, each of the computing devices 300 and 400 may include a processor 21, a memory 22, a communication module 23, an input module 24, and a display module 25. Various components included in the computing devices 300 and 400 may be designed to be incorporated within the housings of the computing devices 300 and 400.

In an embodiment, the processor 21 may control the overall operation of the components included in the computing devices 300 and 400 via a product-related information update application stored in the memory 22 to provide an environment for updating product-related information.

For example, the processor 21 may control the operations of the communication module 23 and the input module 24 such that a signal based on user input received through the input module 24 can be transmitted to the electronic shelf label 100 through the communication module 23.

The processor 21 may include a central processing unit (CPU) and/or a graphics processing unit (GPU). Additionally, the processor 21 may include at least one of application specific integrated circuits (ASICs), digital signal processors (DSPs), digital signal processing devices (DSPDs), programmable logic devices (PLDs), field programmable gate arrays (FPGAs), controllers, microcontrollers, microprocessors, and other electrical units for performing functions.

The memory 22 may store instructions and data that can be used to create a product-related information update environment. A product-related information update application may be stored in the memory 22. The product-related information update application may provide various types of user interfaces for providing a product-related information update environment.

The memory 22 may include at least one non-transitory computer-readable storage medium and temporary computer-readable storage medium. For example, the memory 22 may be a variety of storage devices such as a ROM, an EPROM, a flash drive, and a hard drive. In addition, the memory 22 may include a web storage that performs a data storage function on the Internet.

The communication module 23 may include various types of communication devices that enable data transmission/reception to/from external devices. For example, the communication module 23 may transmit/receive data to/from the electronic shelf label 100 and/or the server 200 via a wireless network.

The communication module 23 may wirelessly transmit/receive data to/from at least one of a base station, an external terminal, or an arbitrary server over a mobile communication network established through a communication device capable of performing technical standards or communication methods for mobile communication (e.g., Long Term Evolution (LTE), Long Term Evolution-Advanced (LTE-A), 5G NR (New Radio), or Wi-Fi) or short-range communication methods.

Furthermore, the communication module 23 may be configured to transmit/receive data to/from an external electronic device via Bluetooth. For example, the communication module 23 may receive a pairing signal from the electronic shelf label 100 and pair with the electronic shelf label 100 via Bluetooth.

The input module 24 may be configured to receive various types of user input from the users using the computing devices 300 and 400. For example, the input module 24 may include a touch screen for receiving a user touch input. If the input module 24 is implemented as a touch screen, the input module 24 may be formed integrally with the display module 25. However, the present disclosure is not limited thereto, and the input module 24 may further include a keyboard capable of receiving user input in the form of characters.

The display module 25 may display the product-related information update application stored in the memory 22. For example, the display module 25 may include a display device that displays various types of user interface (UI) images for providing a product-related information update environment.

The display module 25 may include any one of a liquid crystal display (LCD), a thin film transistor-liquid crystal display (TFT LCD), an organic light-emitting diode (OLED), a flexible display, and a 3D display.

### -Structure of Electronic Shelf Labels 100, 101, 102, 103, 104, 105, and 106

Referring to FIG. 4, a window 110 may be provided on the front surface of the electronic shelf label 100. The window 110 may be provided on a portion of the front surface of the electronic shelf label 100 and may include a display area DA in which product-related information is displayed and a non-display area NDA in which product-related information is not displayed. The non-display area NDA may be an area surrounding the display area DA.

Furthermore, the electronic shelf label 100 may include at least one button 1 and LED 10. For example, the LED 10 may be provided in the non-display area NDA.

The LED 10 may be controlled based on a signal from the server 200 or the computing device 300 or 400. Additionally, the LED 10 may emit various colors. For example, the LED 10 may emit various colors such as blue, red, green, yellow, sky blue, gray, and white.

The button 1 may be provided in a portion of the side of the electronic shelf label 100. However, the present disclosure is not limited thereto, and the button 1 may be provided on the front or rear surface of the electronic shelf label 100. A pairing signal may be transmitted from the electronic shelf label 100 to the computing device 300 or 400 based on a user input via the button 1. Accordingly, the electronic shelf label 100 may be paired with the computing device 300 or 400 using Bluetooth. For example, when a user presses the button 1, a pairing signal is transmitted from the electronic shelf label 100 to the computing device 300 or 400, and thus the electronic shelf label 100 can be paired with the computing device 300 or 400 based on the Bluetooth function.

Referring to FIG. 5, the electronic shelf label 100 may include the window 110 and a main case 120 provided on the rear side of the window 110. The window 110 may expose product-related information to the front, and the main case 120 may be coupled to the rear side of the window 110 to form an internal space in which internal components of the electronic shelf label 100 can be provided. Here, the front side of the window 110 refers to a surface in the z-axis direction, and the rear side refers to a surface in the −z-axis direction.

In this case, the window 110 can cover the entire front surface of the main case 120. For example, the outer side surface 110C of the window 110 and the outer side surface 120C of the main case 120 may be disposed on the same line.

However, the present disclosure is not limited thereto, and the side surface of the window 110 may be surrounded by the main case 120. For example, a portion of the main case 120 may extend to the side surface of the window 110, and the extended portion of the main case 120 may be formed to contact the side surface of the window 110.

Referring to FIG. 6, the electronic shelf label 100 may include a rear cover 150 coupled to the rear surface of the main case 120. The rear cover 150 may be coupled to the rear surface of the main case 120 to protect the internal components of the electronic shelf label 100 from external forces.

The rear cover 150 may include a protrusion 150p formed in the lateral direction (x-axis direction) of the electronic shelf label 100. A predetermined groove may be formed between the protrusion 150p and the main case 120, and the user may open the rear cover 150 by applying force to the protrusion 150p through the predetermined groove to separate the rear cover 150 from the main case 120.

Internal components of the electronic shelf label 100 will be described in detail with reference to FIG. 7 and FIG. 8. For convenience of description, a display module 130, a printed circuit board 140, a battery 160, and a sealing member 26 are omitted in FIG. 8.

Referring to FIG. 7 and FIG. 8, the electronic shelf label 100 may include the window 110, the main case 120 coupled to the rear surface 110B of the window 110, the display module 130 provided in a first internal space a1 formed between the rear surface 110B of the window 110 and the main case 120 to display product information, the printed circuit board 140 provided in the first internal space a1 and electrically connected to the display module 130, the rear cover 150 coupled to the rear surface of the main case 120, the battery 160 provided in a second internal space a2 formed between the main case 120 and the rear cover 150, and the sealing member 26 provided on the side surface of the rear cover 150.

The window 110 may have a flat shape including a front surface 110A and the rear surface 110B. The window 110 may externally expose product-related information displayed by the display module 130 through the front surface 110A. Specifically, the window 110 may be formed of a glass material and may transmit image information output from the display module 130. The shape and size of the display area DA of the window 110 described with reference to FIG. 4 may correspond to the shape and size of the area of the display module 130 where image information is output.

The window 110 may cover the entire front side of the main case 120. In this case, the window 110 may cover the entire front side of the main case 120 such that the window 110 and the main case 120 overlap when viewed from the front side of the window 110.

In addition, the window 110 and the main case 120 may be aligned with each other such that the outer side surface 110C of the window 110 and the outer side surface 120C of the main case 120 are disposed on the same line. Accordingly, when viewed from the front of the window 110, the outer side surface 110C of the window 110 surrounded by a portion of the main case 120 is not observed, and thus the structural integrity of the front of the electronic shelf label 100 is improved, thereby improving the esthetics of the electronic shelf label 100.

The main case 120 may be coupled to the rear surface of the window 110 to form an internal space in which the display module 130, the printed circuit board 140, and the battery 160 are provided. Specifically, the main case 120 may form the first internal space a1 in which the display module 130 and the printed circuit board 140 are provided, and the second internal space a2 in which the battery 160 is provided.

The first internal space a1 and the second internal space a2 may be spatially separated spaces. Specifically, the first internal space a1 and the second internal space a2 may be spatially separated by a plate 121 formed in the center of the first main case 120. The first internal space a1 may be provided above the plate 121, and the second internal space a2 may be provided under the plate 121.

For example, the main case 120 may include the flat plate 121, a first protrusion 122 protruding upward from an edge region of the upper surface of the plate 121, and a second protrusion 123 protruding downward from an edge region of the lower surface of the plate 121.

The first internal space a1 may be an area surrounded by the window 110, the plate 121, and the first protrusion 122. The second internal space a2 may be an area surrounded by the rear cover 150, the plate 121, and the second protrusion 123.

The edge region of the upper surface of the main case 120 may contact the edge region of the lower surface of the window 110. In this case, a bonding member (not shown) may be provided in at least a portion of the space between the edge region of the upper surface of the main case 120 and the edge region of the lower surface of the window 110. The window 110 and the main case 120 may be joined by this bonding member.

For example, the first protrusion 122, which protrudes upward from the edge region of the upper surface of the plate 121, may contact the edge region of the lower surface of the window 110. In this case, the bonding member may be provided in at least a portion of the space between the first protrusion 122 and the edge region of the lower surface of the window 110.

The area of a projection surface of the first internal space a1 with respect to the front surface of the window 110 may be larger than the area of a projection surface of the second internal space a2 with respect to the front surface of the window 110. For example, when the horizontal width of the projection surface of the first internal space a1 with respect to the front surface of the window 110 is identical to the horizontal width of the projection surface of the second internal space a2 with respect to the front surface of the window 110, the vertical width of the projection surface of the first internal space a1 with respect to the front surface of the window 110 may be greater than the vertical width of the projection surface of the second internal space a2 with respect to the front surface of the window 110.

In addition, when the vertical width of the projection surface of the first internal space a1 with respect to the front surface of the window 110 is identical to the vertical width of the projection surface of the second internal space a2 with respect to the front surface of the window 110, the horizontal width of the projection surface of the first internal space a1 with respect to the front surface of the window 110 may be greater than the horizontal width of the projection surface of the second internal space a2 with respect to the front surface of the window 110.

Furthermore, the vertical width of the projection surface of the first internal space a1 with respect to the front surface of the window 110 may be greater than the vertical width of the projection surface of the second internal space a2 with respect to the front surface of the window 110, and at the same time, the horizontal width of the projection surface of the first internal space a1 with respect to the front surface of the window 110 may be greater than the horizontal width of the projection surface of the second internal space a2 with respect to the front surface of the window 110.

A plurality of protrusions 124 and 125 may be formed on the lower surface of the main case 120 to form a mounting recess into which the battery 160 can be mounted. The plurality of protrusions 124 and 125 may protrude downward from the lower surface of the plate 121 included in the main case 120. The battery 160 may be mounted between the plurality of protrusions 124 and 125, and the battery 160 may be supported by the plurality of protrusions 124 and 125.

In addition, an insertion hole h1 into which the button 1 may be inserted may be formed on a portion of the side surface of the main case 120. For example, the insertion hole h1 may be formed on a portion of the side surface of the first protrusion 122.

The button 1 inserted into the insertion hole h1 may be coupled to the printed circuit board 140 provided in the first internal space a1. Specifically, the button 1 may be coupled to a button input receiver of the printed circuit board 140 through the insertion hole h1.

The display module 130 may display product-related information. For example, the display module 130 may include an electronic paper display (EPD). E-paper displays are suitable for electronic shelf labels 100 that require reduced power consumption due to their bistability, which maintains the display state for a long period of time even when power supply is interrupted.

Known examples of e-paper displays include a twist ball type using a hemispherical twist ball charged with electrostatic charge, an electrophoretic display utilizing electrophoresis and microcapsules, and a cholesterol liquid crystal display using cholesterol liquid crystals.

However, the present disclosure is not limited thereto, and the display module 130 may include any one of a liquid crystal display (LCD), a thin film transistor-liquid crystal display (TFT LCD), an organic light-emitting diode (OLED), a flexible display, and a 3D display.

The printed circuit board 140 may be electrically connected to the display module 130 to drive the display module 130. The printed circuit board 140 may be disposed on the rear surface of the display module 130. One or more electronic components for driving the electronic shelf label 100 may be mounted on the front or rear surface of the printed circuit board 140. The printed circuit board 140 may be formed in a plate shape. The printed circuit board 140 may receive power from the battery 160 disposed on the rear side thereof.

The rear cover 150 may be coupled to the rear surface of the main case 120 to form the second internal space a2 in which the battery 160 is provided. The rear cover 150 may cover the battery 160 to prevent damage to the battery 160 due to external force.

The rear cover 150 may be provided to be surrounded by the inner surface of the main case 120. For example, the rear cover 150 may be provided to be surrounded by the inner surface of the second protrusion 123. In this case, the lower surface of the rear cover 150 and the lower surface of the second protrusion 123 may be disposed on the same line. Since the rear cover 150 is provided to be surrounded by the inner surface of the main case 120, the overall structural stability of the electronic shelf label 100 can be improved.

However, the protrusion 150p of the rear cover 150 may be formed to extend to the lower surface of the second protrusion 123. Accordingly, the end of the protrusion 150p of the rear cover 150 can be disposed on the same line as the outer surface of the second protrusion 123.

The rear cover 150 may include a third protrusion 151 that protrudes upward from the edge region of the upper surface of the rear cover 150. The end of the third protrusion 151 may have a hook shape. In this case, the end of the third protrusion 151 may contact the upper surface of the plate 121, and thus the end of the third protrusion 151 may be supported by the plate 121. The third protrusion 151 may be surrounded by the second protrusion 123 of the main case 120.

The third protrusion 151 may include a first sub-protrusion p1 that protrudes laterally from a portion of the side surface of the third protrusion 151. For example, the first sub-protrusion p1 may be formed to protrude from the side surface of the protrusion 151 toward the outer side surface 120C of the main case 120.

A joining hole h2 may be formed in a portion of the plate 121 of the main case 120. The third protrusion 151 of the rear cover 150 may be inserted into the joining hole h2.

Additionally, the second protrusion 123 of the main case 120 may include a second sub-protrusion p2 that protrudes laterally from a portion of the side surface of the second protrusion 123. For example, the second sub-protrusion p2 may be formed to protrude from the side surface of the second protrusion 123 toward the inner surface of the main case 120.

The first sub-protrusion p1 may be formed to support the lower portion of the second sub-protrusion p2. In this case, the second sub-protrusion p2 may be fitted into a groove formed between the end of the third protrusion 151 of the rear cover 150 and the first sub-protrusion p1. Accordingly, the third protrusion 151 of the rear cover 150 and the second protrusion 123 of the main case 120 can be coupled to each other.

Meanwhile, the sealing member 26 may be provided on the side of the rear cover 150. For example, a sealing groove may be formed on the outer side surface of the rear cover 150, and sealing member 26, 27 may be provided in the sealing groove. The sealing member 26 may be provided on the side of the rear cover 150 and may come into contact with the inner surface of the main case 120 surrounding the side of the rear cover 150.

The sealing member 26 may have a closed-loop shape surrounding the side of the rear cover 150. For example, a closed-loop sealing groove surrounding the rear cover 150 may be formed on the outer side surface of the rear cover 150, and the sealing member 26 may be provided in the closed-loop sealing groove. In this case, the sealing groove may be formed on the outer side surface of the third protrusion 151 of the rear cover 150, and the sealing member 26 may be provided in the sealing groove.

The sealing member 26 may include rubber. However, the present disclosure is not limited thereto, and the sealing member 26 may include a material having a waterproof function other than rubber.

The battery 160 may provide power required to drive the display module 130 and the printed circuit board 140. For example, the battery may be accommodated in the second internal space a2. A terminal for electrical connection with the battery 160 may be formed on the rear or inner surface of the main case 120. Accordingly, power for driving the printed circuit board 140 or the display module 130 can be supplied from the battery 160.

For example, the battery 160 may include a coin-shaped battery. However, the present disclosure is not limited thereto, and the battery 160 may include various types of batteries. The rear cover 150 is formed to be detachable from the main case 120, and the battery 160 can be replaced by opening the rear cover 150.

FIG. 9 illustrates an exemplary configuration of an electronic shelf label 101 according to another embodiment.

The electronic shelf label 101 of FIG. 9 is substantially the same as the electronic shelf label 100 of FIG. 7, except that the shape of a third protrusion 153 formed on a rear cover 152 is different from the shape of the third protrusion 151 and the shape of a main case 170 is different from the shape of the main case 120. Therefore, in describing the configuration shown in FIG. 9, any component identical to those shown in FIG. 4 to FIG. 8 will be omitted.

Referring to FIG. 9, the electronic shelf label 101 may include the window 110, the main case 170, the display module 130, the printed circuit board 140, the rear cover 152, and the battery 160.

The display module 130 and the printed circuit board 140 may be provided in a first internal space a3 formed by the window 110 and the main case 170. The battery 160 may be provided in a second internal space a4 formed by the main case 170 and the rear cover 150.

The main case 170 may include a flat plate 171, a first protrusion 172 protruding upward from an edge region of the upper surface of the plate 171, and a second protrusion 173 protruding downward from an edge region of the lower surface of the plate 171.

In this case, the first protrusion 172 may be formed further outward from the plate 171 than the second protrusion 173. Accordingly, the lateral width of the first internal space a3 may be greater than the lateral width of the second internal space a4.

The rear cover 152 may be provided to be surrounded by the inner surface of the main case 170. For example, the rear cover 152 may be provided to be surrounded by the inner surface of the second protrusion 173. In this case, the lower surface of the rear cover 152 and the lower surface of the second protrusion 173 may be disposed on the same line.

The rear cover 152 may include a third protrusion 153 protruding upward from an edge region of the upper surface of the rear cover 152. The end of the third protrusion 153 may have a hook shape. In this case, the end of the third protrusion 153 may contact the upper surface of the plate 171, and thus the end of the third protrusion 153 may be supported by the plate 171. The third protrusion 153 may be surrounded by the second protrusion 173 of the main case 170.

A joining hole h3 may be formed in a portion of the plate 171 of the main case 170. The third protrusion 153 of the rear cover 152 may be inserted into the joining hole h3.

Additionally, the second protrusion 173 of the main case 170 may include a sub-protrusion p3 that protrudes laterally from a portion of the side surface of the second protrusion 173. For example, the sub-protrusion p3 may be formed to protrude from the side surface of the second protrusion 173 toward the inner surface of the main case 170.

In this case, the sub-protrusion p2 may be formed to support the end of the third protrusion 153 of the rear cover 152. For example, a joining recess f1 may be formed at the lower end of the end of the third protrusion 153, and the sub-protrusion p2 may be fitted into the joining recess f1. Accordingly, the third protrusion 153 of the rear cover 152 and the second protrusion 173 of the main case 170 can be coupled to each other.

In addition, sealing grooves 38 and 39 into which sealing members 36 and 37 can be inserted may be formed on the outer side surface of the protrusion 153 of the rear cover 152. Specifically, a first sealing groove 38 and a second sealing groove 39 may be formed on the outer side surface of the third protrusion 153. The first sealing groove 38 and the second sealing groove 39 may have a closed loop shape along the outer surface of the third protrusion 153.

A first sealing member 36 may be inserted into the first sealing groove 38, and a second sealing member 37 may be inserted into the second sealing groove 39. The first sealing member 36 and the second sealing member 37, like the first sealing groove 38 and the second sealing groove 39, may also have a closed loop shape along the outer surface of the third protrusion 153.

The first sealing member 36 and the second sealing member 37 may be positioned within a gap formed between the main case 170 and the rear cover 152, thereby sealing the second internal space in which the battery 160 is provided. Accordingly, the first and second sealing members 36 and 37 can prevent external foreign substances and moisture from entering the second internal space in which the battery 160 is provided.

The first sealing member 36 and the second sealing member 37 may be formed of an elastically deformable material. For example, the first sealing member 36 and the second sealing member 37 may include rubber.

FIG. 10 illustrates an exemplary configuration of an electronic shelf label 102 according to another embodiment.

The electronic shelf label 102 of FIG. 10 may be substantially the same as the electronic shelf label 100 of FIG. 7, except that the shape of a third protrusion 155 formed on a rear cover 154 differs from the third protrusion 151 and the shape of a main case 180 differs from the shape of the main case 120. Therefore, in describing the configuration shown in FIG. 10, any component identical to those shown in FIG. 4 to FIG. 8 will be omitted.

Referring to FIG. 10, the electronic shelf label 102 may include the window 110, the main case 180, the display module 130, the printed circuit board 140, the rear cover 154, and the battery 160.

The main case 180 may include a flat plate 181, a first protrusion 182 protruding upward from an edge region of the upper surface of the plate 181, and a second protrusion 183 protruding downward from an edge region of the lower surface of the plate 181.

In this case, the first protrusion 182 may be formed further outward from the plate 181 than the second protrusion 183. Accordingly, the lateral width of the first internal space in which the display module 130 and the printed circuit board 140 are provided may be greater than the lateral width of the second internal space in which the battery 160 is provided.

The rear cover 154 may be provided to be surrounded by the inner surface of the main case 180. For example, the rear cover 154 may be provided to be surrounded by the inner surface of the second protrusion 183. In this case, the lower surface of the rear cover 154 and the lower surface of the second protrusion 183 may be disposed on the same line.

The rear cover 154 may include the third protrusion 155 protruding upward from an edge region of the upper surface of the rear cover 154. The end of the third protrusion 155 may have a hook shape. In this case, the hook-shaped end of the third protrusion 155 may face the battery 160. For example, the hook-shaped end of the third protrusion 155 may contact a portion of the battery 160. The third protrusion 155 may be surrounded by the second protrusion 183 of the main case 180.

A joining hole h4 may be formed in a portion of the plate 181 of the main case 180. The third protrusion 155 of the rear cover 154 may be inserted into the joining hole h4.

In addition, the second protrusion 183 of the main case 180 may include a first sub-protrusion p4 that protrudes laterally from a portion of the side surface of the second protrusion 183. In this case, the first sub-protrusion p4 may be formed on the inner surface of the second protrusion 183. For example, the first sub-protrusion p4 may be formed to protrude from the side surface of the second protrusion 173 toward the inner surface of the main case 180.

Furthermore, the third protrusion 155 of the rear cover 154 may include a second sub-protrusion p5 that protrudes laterally from a portion of the side surface of the third protrusion 155. In this case, the second sub-protrusion p5 may be formed on the outer surface of the third protrusion 155. For example, the second sub-protrusion p5 may be formed to protrude from the side surface of the third protrusion 183 in the direction in which the second protrusion 183 is provided.

In this case, the first sub-protrusion p4 of the second protrusion 183 and the second sub-protrusion p5 of the third protrusion 155 may be formed to support each other. Accordingly, the third protrusion 155 of the rear cover 154 and the second protrusion 183 of the main case 180 may be coupled to each other.

In addition, a sealing recess f2 into which a sealing member 40 may be inserted may be formed on the outer side surface of the third protrusion 155 of the rear cover 154. Specifically, the sealing recess f2 may be formed on the outer side surface of the third protrusion 155. The sealing recess f2 may have a closed loop shape along the outer surface of the third protrusion 155.

The sealing member 40 may be inserted into the sealing recess f2. Like the sealing recess f2, the sealing member 40 may have a closed loop shape along the outer surface of the third protrusion 155.

FIG. 11 illustrates an exemplary configuration of an electronic shelf label 103 according to another embodiment.

The electronic shelf label 103 of FIG. 11 may be substantially the same as the electronic shelf label 100 of FIG. 7, except that the shape of a third protrusion 157 formed on a rear cover 156 is different from the shape of the third protrusion 151 and the shape of a main case 184 is different from the shape of the main case 120. Therefore, in describing the configuration shown in FIG. 11, any component identical to those shown in FIG. 4 to FIG. 8 will be omitted.

Referring to FIG. 11, the electronic shelf label 103 may include the window 110, the main case 184, the display module 130, the printed circuit board 140, the rear cover 156, and the battery 160.

The main case 184 may include a flat plate 185, a first protrusion 186 protruding upward from an edge region of the upper surface of the plate 185, and a second protrusion 187 protruding downward from an edge region of the lower surface of the plate 185.

In this case, the first protrusion 186 may be formed further outward from the plate 185 than the second protrusion 187. Accordingly, the lateral width of the first internal space in which the display module 130 and the printed circuit board 140 are provided may be greater than the lateral width of the second internal space in which the battery 160 is provided.

The rear cover 156 may be provided to be surrounded by the inner surface of the main case 184. For example, the rear cover 156 may be provided to be surrounded by the inner surface of the second protrusion 187. In this case, the lower surface of the rear cover 156 and the lower surface of the second protrusion 187 may be disposed on the same line.

The rear cover 156 may include the third protrusion 157 protruding upward from an edge region of the upper surface of the rear cover 156. The end of the third protrusion 157 may have a first hook shape. In this case, the end of the third protrusion 157 having the first hook shape may face the battery 160. The third protrusion 157 may be surrounded by the second protrusion 187 of the main case 184.

A joining hole h5 may be formed in a portion of the plate 185 of the main case 184. The third protrusion 157 of the rear cover 156 may be inserted into the joining hole h5.

Furthermore, a fourth protrusion 188 protruding downward may be formed in a portion of the plate 185 of the main case 184. The end of the fourth protrusion 188 may have a second hook shape formed to engage with the first hook shape of the third protrusion 157. The end of the fourth protrusion 188 having the second hook shape may face the main case 184.

In this case, the end of the third protrusion 157 and the end of the fourth protrusion 188 may be formed to engage with each other and support each other. Accordingly, the third protrusion 157 of the rear cover 156 and the plate 185 of the main case 184 can be coupled to each other.

Furthermore, a sealing member 40 may be provided on the outer side surface of the third protrusion 157 of the rear cover 156. The sealing member 40 may have a closed loop shape along the outer side surface of the third protrusion 157.

FIG. 12 illustrates a bonding state between the window 110 and a main case 190 of an electronic shelf label 104 according to another embodiment.

The electronic shelf label 104 of FIG. 12 may be substantially the same as the electronic shelf label 100 of FIG. 7, except that a bonding member 51 is provided between the main case 190 and the window 110. Therefore, in describing the configuration shown in FIG. 12, any component identical to those shown in FIG. 4 to FIG. 8 will be omitted.

Referring to FIG. 12, a step s1 may be formed on the edge region of the upper surface of the main case 190. For example, the step s1 may be formed on the upper surface of a first protrusion protruding upward from the edge region of the upper surface of the main case 190. The step s1 may be formed so as not to be exposed to the outside of the main case 190.

The bonding member 51 may be provided on the step s1. The bonding member 51 may extend from the step s1 to the center of the window 110. In this case, the bonding member 51 may include a double-sided tape layer. The window 110 and the main case 190 may be bonded by the bonding member 51.

FIG. 13 illustrates a bonding state between the window 110 and the main case 191 of an electronic shelf label 105 according to another embodiment.

The electronic shelf label 105 of FIG. 13 may be substantially the same as the electronic shelf label 100 of FIG. 7, except that a bonding member 52 is provided between the main case 191 and the window 110. Therefore, in describing the configuration shown in FIG. 13, any component identical to those shown in FIG. 4 to FIG. 8 will be omitted.

Referring to FIG. 13, a step s2 may be formed on the edge region of the upper surface of the main case 191. For example, the step s2 may be formed on the upper surface of a first protrusion protruding upward from the edge region of the upper surface of the main case 191. The step s2 may be formed so as not to be exposed to the outside of the main case 191.

The bonding member 52 may be provided on the step s2. The bonding member 52 may be formed to be provided only in the area where the lower surface of the window 110 and the upper surface of the first protrusion of the main case 191 overlap. Accordingly, the bonding member 52 may be formed so as not to protrude outside the step s2. In this case, the bonding member 52 may include at least one of a hot melt layer or an epoxy layer. The window 110 and the main case 191 can be bonded by the bonding member 52.

FIG. 14 illustrates a bonding state between the window 110 and the main case 192 of an electronic shelf label 106 according to another embodiment.

The electronic shelf label 106 of FIG. 14 may be substantially the same as the electronic shelf label 100 of FIG. 7, except that a bonding member 53 is provided between the main case 192 and the window 110. Therefore, in describing the configuration shown in FIG. 14, any component identical to those shown in FIG. 4 to FIG. 8 will be omitted.

Referring to FIG. 14, a step s3 may be formed on the edge region of the upper surface of the main case 192. For example, the step s3 may be formed on the upper surface of a first protrusion protruding upward from the edge region of the upper surface of the main case 192. The step s3 may be formed to be exposed to the outside of the main case 192. The step s3 may include an inclined surface formed on a portion of the outer surface of the first protrusion of the main case 192.

The bonding member 53 may be provided on the step s3. By providing the bonding member 53 on the step s3 formed to be exposed to the outside of the main case 192, a side surface of the bonding member 53 may be exposed to the outside of the main case 192. In this case, the bonding member 53 may include at least one of a hot melt layer or an epoxy layer. The window 110 and the main case 192 can be bonded by the bonding member 53.

### -Methods S100 and S200 of Manufacturing Electronic Shelf Label

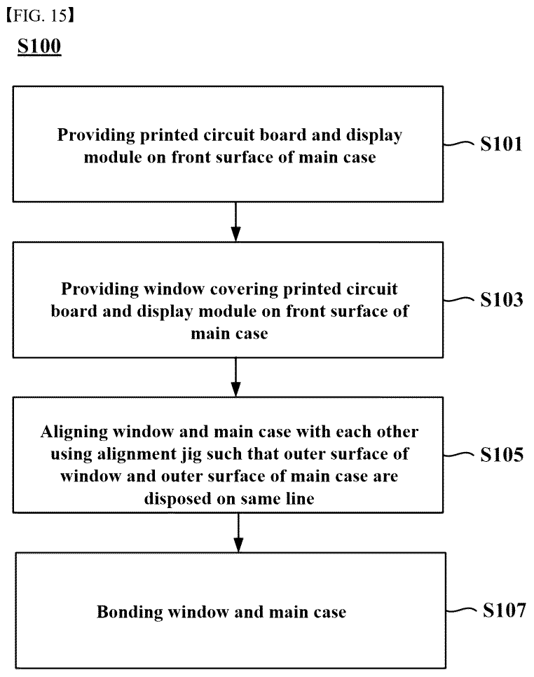

Hereinafter, methods S100 and S200 of manufacturing the electronic shelf label according to various embodiments will be described in detail with reference to FIG. 15 to FIG. 17. In describing the methods S100 and S200 of manufacturing the electronic shelf label with reference to FIG. 15 to FIG. 17, reference will be made to the symbols of the components included in the electronic shelf label 100 of FIG. 7 and FIG. 8.

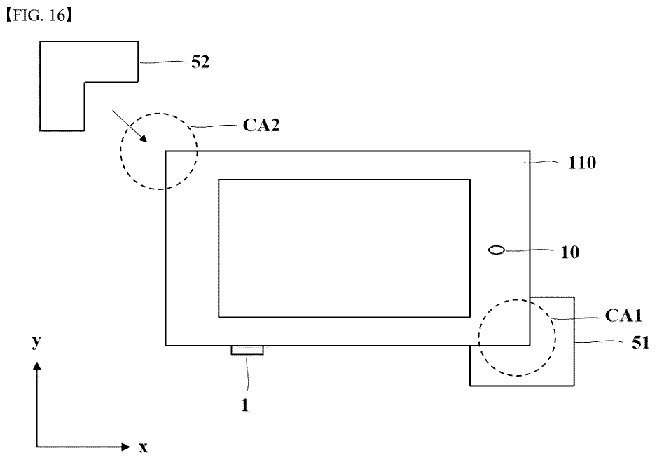

FIG. 15 is a flowchart of the method S100 of manufacturing the electronic shelf label according to an embodiment. FIG. 16 illustrates a method of aligning the window 110 and the main case 120 of the electronic shelf label 100 according to an embodiment.

Referring to FIG. 15, the method S100 of manufacturing the electronic shelf label may include step S101 of providing the printed circuit board 140 and the display module 130 on the front of the main case 120, step S103 of providing the window 110 covering the printed circuit board 140 and the display module 130 on the front of the main case 120, step S105 of aligning the window 110 and the main case 120 with each other such that the outer side surface 110C of the window 110 and the outer side surface 120C of the main case 120 are disposed on the same line using alignment jigs 51 and 52, and step S107 of bonding the window 110 and the main case 120.

In step S101, the printed circuit board 140 and the display module 130 may be sequentially provided on the front surface of the main case 120. For example, the printed circuit board 140 may be provided in the first internal space a1 of the main case 120, and the display module 130 may be provided on the printed circuit board 140. In this case, the display module 130 and the printed circuit board 140 may be electrically connected by a lead wire (not shown).

In step S103, the window 110 that transmits image information output from the display module 130 may be provided on the front surface of the main case 120 to cover the display module 130. In this case, the window 110 may be provided such that the edge region of the lower surface of the window 110 contacts the edge region of the upper surface of the main case 120.

The lower surface of the window 110 and the upper surface of the main case 120, which face each other, may have shapes corresponding to each other. Specifically, the lower surface of the window 110 and the upper surface of the main case 120, which face each other, may have the same shape and area.

In step S105, the window 110 and the main case 120 may be aligned using the alignment jigs 51 and 52 having shapes corresponding to portions of the outer side surface 110C of the window 110 and the outer side surface 120C of the main case 120.

For example, referring to FIG. 16, the first alignment jig 51 may be positioned to surround a first corner area CA1 of the outer side surface 110C of the window 110 and a first corner area CA1 of the outer side surface 120C of the main case 120, which face each other. Here, the first alignment jig 51 may be a fixed jig with a fixed position.

After the first alignment jig 51 is positioned at the first corner area CA1, the second alignment jig 52 may be positioned to surround a second corner area CA2 of the outer side surface 110C of the window 110 and a second corner area CA2 of the outer side surface 120C of the main case 120, which face each other. Here, the second alignment jig 52 may be a movable jig.

In this way, by positioning the first alignment jig 51 such that the first alignment jig 51 contacts the first corner area CA1 and positioning the second alignment jig 52 such that the second alignment jig 52 contacts the second corner area CA2, the window 110 and the main case 120 can be aligned with each other such that the outer side surface 110C of the window 110 and the outer side surface 120C of the main case 120 are disposed on the same line.

However, the present disclosure is not limited thereto, and four fixed jigs may be respectively installed in four corner areas of the window 110 and the main case 120 facing each other in step S105. After the fixed jigs are installed, the window 110 and the main case 120 may be aligned by positioning a structure in which the window 110 and the main case 120 face each other in the area surrounded by the fixed jigs.

In step S107, the aligned window 110 and main case 120 may be bonded. For example, the window 110 and the main case 120 can be bonded by providing a bonding member between the edge region of the lower surface of the window 110 and the edge region of the upper surface of the main case 120.

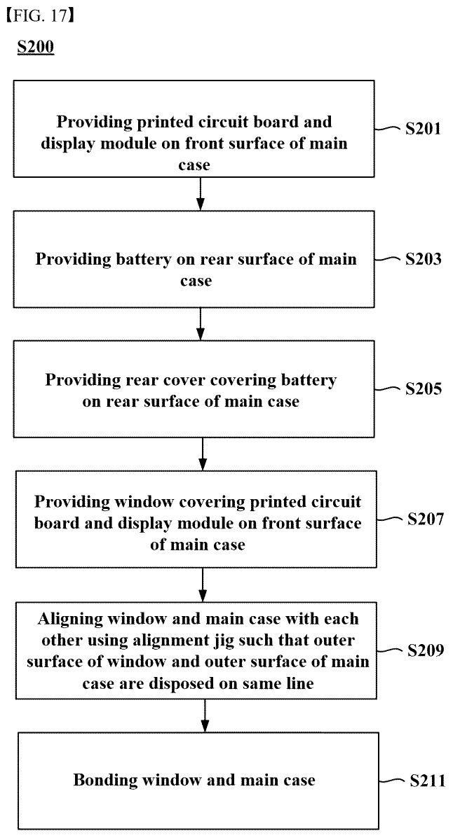

FIG. 17 is a flowchart of a method S200 of manufacturing the electronic shelf label according to another embodiment.

Referring to FIG. 17, the method S200 of manufacturing the electronic shelf label may include step S201 of providing the printed circuit board 140 and the display module 130 on the front surface of the main case 120, step S203 of providing the battery 160 on the rear surface of the main case 120, step S205 of providing the rear cover 150 covering the battery 160 on the rear surface of the main case 120, step S207 of providing the window 110 covering the printed circuit board 140 and the display module 130 on the front surface of the main case 120, step S209 of aligning the window 110 and the main case 120 such that the outer side surface 110C of the window 110 and the outer side surface 120C of the main case 120 are disposed on the same line using the alignment jigs 51 and 52, and step S211 of bonding the window 110 and the main case 120.

Steps S201, S207, S209, and S211 may be substantially the same as steps S101, S103, S105, and S107 of FIG. 13. Therefore, in describing the method shown in FIG. 17, descriptions of steps S201, S207, S209, and S211 will be omitted.

In step S203, the battery 160 may be provided in the second internal space a2 of the main case 120. In this case, the height of the second internal space a2 may be equal to or greater than the height of the battery 160.

In step S205, the rear cover 150 may be combined with the rear surface of the main case 120 to prevent the battery 160 provided in the second internal space a2 of the main case 120 from being exposed to the outside.

Steps S203 and S205 may be performed before or after step S207. However, the present disclosure is not limited thereto, and steps S203, S205, and S207 may be performed substantially simultaneously.

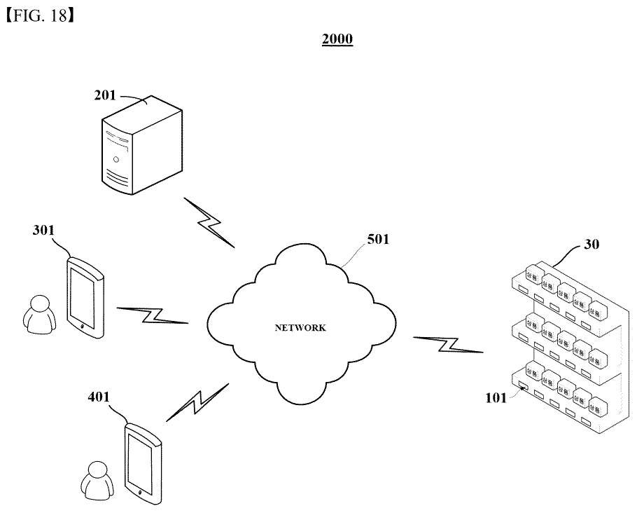

Meanwhile, referring to FIG. 18, a product-related content provision system 2000 according to an embodiment may be provided.

### -System 2000

Referring to FIG. 18, the product-related content provision system 2000 according to an embodiment may include an electronic shelf label 101, a server 201, and computing devices 301 and 401. The computing devices 301 and 401 may include portable user terminals. The system 2000 may provide customers with content related to products they wish to purchase based on user input.

The electronic shelf label 101, the server 201, and the computing devices 301 and 401 may be connected to each other via a network 501. Here, the network 501 according to the embodiment may refer to a connection architecture that enables information exchange between nodes, such as the electronic shelf label 101, the server 201, and the computing devices 301 and 401.

Since the network 501 is substantially the same as the network 500 described with reference to FIG. 1, a description of the network 501 is omitted here.

The electronic shelf label 101 may be wirelessly connected to the server 201 via a separate gateway (not shown). However, the present disclosure is not limited thereto, and the electronic shelf label 101 may be connected to the computing devices 301 and 401 via wireless communication. For example, the electronic shelf label 101 can be paired with the computing device 301 or 401 based on the Bluetooth function.

Hereinafter, the electronic shelf label 101, the server 201, and the computing devices 301 and 401 included in the system 2000 will be described in detail with reference to the attached drawings.

### -Electronic Shelf Label 101

The electronic shelf label 101 may be an electronic device mounted on a shelf 30 and displaying information related to products displayed on the shelf 30. For example, the electronic shelf label 101 may display product-related information such as a Korean product name, an English product name, a product origin, a product price, raw materials, and weight/calories.

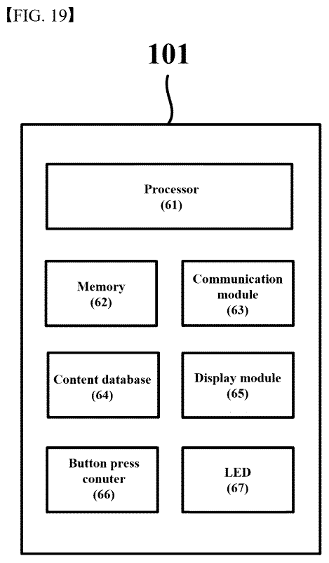

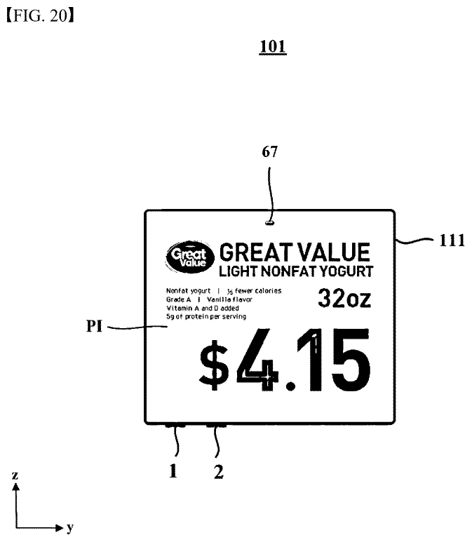

Referring to FIG. 19 and FIG. 20, the electronic shelf label 101 may be implemented as a computing device including a processor 61, a memory 62 storing application programs, data, and/or instructions, at least one communication module 63 for data exchange with external devices, a content database 64 storing product-related content, a display module 65 displaying product-related information, a button press counter 66 for measuring the number of times a user presses buttons 1 and 2, and an LED 67. Furthermore, the electronic shelf label 101 may be equipped with components and programs capable of Bluetooth communication.

The processor 61 may control the overall operation of components included in the electronic shelf label 101 to provide an environment capable of providing product-related content.

For example, the processor 61 can control the operation of the display module 65 such that display product-related information is displayed on the display module 65. Furthermore, the processor may retrieve product-related content corresponding to product-related information displayed on the display module 65 from the content database 64 based on user input via the buttons 1 and 2.

The processor 61 may be a system-on-chip (SOC) including a central processing unit (CPU) and/or a graphics processing unit (GPU), and may execute an operating system (OS) and/or application programs stored in the memory 62.

Furthermore, the processor 61 may internally communicate with each component included in the electronic shelf label 101 via a system bus and may include one or more predetermined bus structures, including a local bus.

In addition, the processor 61 may be implemented using at least one of application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electrical units for performing functions.

Referring to FIG. 20, the electronic shelf label 101 may include one or more buttons 1 and 2. For example, the electronic shelf label 101 may include a first button 1 and a second button 2. The first button 1 and the second button 2 may be provided on an area of the outer surface of the electronic shelf label 100.

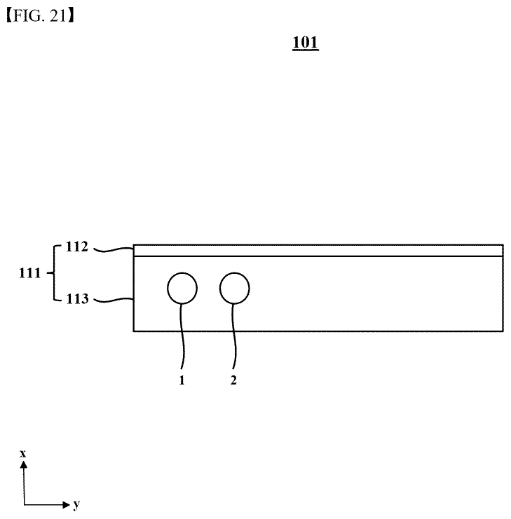

For example, referring to FIG. 21, the electronic shelf label 101 may include a housing 111 in which the display module 65 is mounted. The housing 111 may include a window 112 covering the front of the display module 65 and a rear cover 113 that is coupled to the window 112 to provide an internal space in which the display module 65 is provided.

In this case, the display module 65 may be mounted in the internal space formed by the window 112 and the rear cover 113. Additionally, other components of the electronic shelf label 101 may be provided in the internal space formed by the window 112 and the rear cover 113. The window 112 may be made of a transparent material such that an image or video displayed on the display module 65 can be exposed to the outside.

The first button 1 and the second button 2 may be provided on an area of the external surface of the housing 111. For example, the first button 1 and the second button 2 may be provided side by side and spaced apart on the bottom surface of the rear cover 113. The first button 1 and the second button 2 may penetrate the rear cover 113 and be electrically connected to the processor 61 included in the electronic shelf label 101. Accordingly, the processor 61 can receive user input via the first button 1 and the second button 2.

Meanwhile, a pairing signal may be transmitted from the electronic shelf label 101 to the computing device 301 or 401 based on user input via the first button 1 and/or the second button 2. Accordingly, the electronic shelf label 101 may be paired with the computing device 301 or 401 using Bluetooth. For example, when a user presses the first button 1 and/or the second button 2, a pairing signal is transmitted from the electronic shelf label 101 to the computing device 301 or 401, and the electronic shelf label 101 can be paired with the computing device 301 or 401 based on the Bluetooth function.

For example, when a user presses the first button 1, the processor 61 receives a first user input, and a pairing signal based on the first user input can be transmitted to an external electronic device. Furthermore, when the user presses the second button 2, the processor 61 receives a second user input, and data related to product-related content can be transmitted from the processor 61 to the external electronic device based on the second user input. Here, the external electronic device may be a user terminal type computing device 301 or 401.

The memory 62 may store one or more of an operating system (OS), various application programs, data, and instructions to provide an environment necessary for performing a method of providing product-related content.

In an embodiment, the memory 62 may be a variety of storage devices, such as a ROM, a RAM, an EPROM, a flash drives, and a hard drive and may also be a web storage having a storage function on the Internet. Furthermore, the memory 12 may be a removable storage medium on a server.

The communication module 63 may include various types of communication devices that enable the electronic shelf label 101 to transmit/receive data to/from external devices. The electronic shelf label 101 may transmit data regarding product-related content to computing devices 301 and 401 via the communication module 13.

The content database 64 may store product-related content assigned to the electronic shelf label 101. Here, the product-related content may include advertising content for a product. For example, the product-related content may include videos, animations, images, and detailed product descriptions for promoting the product. However, the present disclosure is not limited thereto, and the product-related content may include various forms of content related to the product other than advertising content.

In response to user input via buttons 1 and 2, the processor 61 may retrieve product-related content corresponding to product-related information displayed on the display module 65 from the content database 64. Product-related content stored in the content database 64 may be edited and stored by a user in advance.

The content database 64 may be included in the electronic shelf label 101, but the present disclosure is not limited thereto, and the content database 64 may be implemented as a separate electronic device external to the electronic shelf label 101.

The display module 65 may display product-related information assigned to the electronic shelf label 101. For example, the display module 65 may display a template with product-related information on the front thereof.

The display module 65 may include an electronic paper display (EPD), which maintains product information display status even when power is not supplied. Electronic paper displays are suitable for the electronic shelf labels 101 which requires reduced power consumption due to their bistability which allows the electronic paper displays to maintain their display status for long periods of time even when power is interrupted. Known electronic paper displays include a twist ball type using electrostatically charged hemispherical twist balls, an electrophoretic display utilizing electrophoresis and microcapsules, and a cholesterol liquid crystal display using cholesterol liquid crystals.

However, the present disclosure is not limited thereto, and the display module 65 may include any one of a liquid crystal display (LCD), a thin film transistor-liquid crystal display (TFT LCD), an organic light-emitting diode (OLED), a flexible display, and a three-dimensional display (3D display).

The button press counter 66 can measure the number of times a user presses the buttons 1 and 2.

For example, a user may press the first button 1, and the processor 61 may receive a first user input resulting from the press of the first button 1. Furthermore, based on the first user input, a pairing signal may be transmitted to an external electronic device, allowing the electronic shelf label 101 to be paired with the external electronic device. In this case, the button press counter 66 can measure the number of times the user presses the first button 1, and accordingly, the number of times the electronic shelf label 101 and the external electronic device are paired can be measured.

Additionally, the user may press the second button 2, and the processor 61 may receive a second user input resulting from the press of the second button 2. Furthermore, data regarding product-related content may be transmitted from the processor 61 to an external electronic device based on the second user input. In this case, the button press counter 66 may measure the number of times the user presses the second button 2, and accordingly, the number of times the data regarding product-related content is transmitted from the electronic shelf label 101 to the external electronic device can be measured. The number of times the data regarding product-related content is transmitted to the external electronic device can be used as data necessary to determine the level of interest in the product of store customers.

Data regarding the number of button presses measured by the button press counter 66 may be transmitted to an external electronic device by the processor 61. For example, the processor 61 may transmit data regarding the number of button presses to a user terminal type computing device 301 or 401 via the communication module 63.

The LED 67 may be a light-emitting device installed on the electronic shelf label 101 that lights up in response to a specific signal. Referring to FIG. 20, the LED 67 may be provided in a different area of the electronic shelf label 101 from the area where product-related information PI is displayed by the display module 65.

The LED 67 may be configured to light up when the processor 61 controls the operation of the display module 65 to display product-related content on the display module 65. The LED 67 may emit light in various colors. For example, the LED 67 may emit light in various colors, such as blue, red, green, yellow, sky blue, gray, and white.

### -Server 201

The server 201 may transmit data regarding product-related content to the electronic shelf label 101 or the user terminal type computing devices 301 and 401 used by store customers such that the customers can easily access content related to products they wish to purchase on-site. The server 201 may perform a series of processes for displaying product-related content on the display module based on user input via the buttons 1 and 2 on the electronic shelf label 101.

Specifically, to perform a method of providing content related to the product assigned to the electronic shelf label 101, the server 201 may exchange necessary data with the electronic shelf label 101 and computing devices 301 and 401 in an embodiment. Accordingly, the server 201 can provide an environment necessary for performing the method of providing the content related to the product.

For example, the server 201 can provide an environment in which a relevant content providing application for a product can operate on the electronic shelf label 101 and the computing devices 301 and 401 (e.g., a portable user terminal type computing device, a desktop type computing device, and/or a fixed kiosk-type computing device). The server 201 may include application programs, data, and/or instructions for the relevant content providing application to operate, and may transmit data based thereon to the electronic shelf label 101 and the computing devices 301 and 401.

Additionally, the server 201 may provide a license key to the computing devices 301 and 401. The server 201 may provide the license key that grants the computing devices 301 and 401 the right to receive data regarding product-related content. For example, store customers using the computing devices 301 and 401 may receive a product-related content provision service by using the computing devices 301 and 401 that have received the license key.

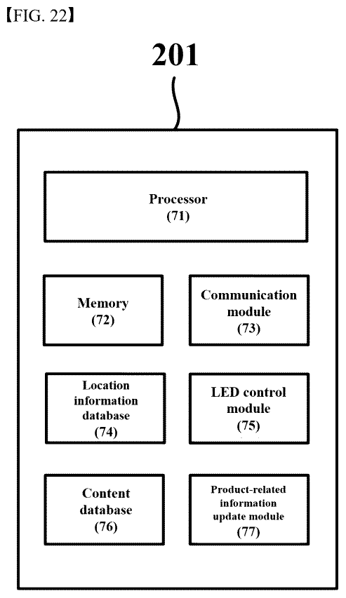

Referring to FIG. 22, the server 201 may be implemented as a computing device including at least one processor 71 for data processing, a memory 72 for storing application programs, data, and/or instructions, at least one communication module 73 for data exchange with external devices, a location information database 74 for storing location information of the electronic shelf label 101, an LED control module 75 for controlling the operation of the LED 67 of the electronic shelf label 101, a content database 76 for storing product-related content, and a product-related information update module 77 for updating product-related information displayed on the electronic shelf label 101.

The processor 71 may control the overall operation of components included in the server 201 to provide an environment in which a product-related content providing application for the electronic shelf label 101 and the computing devices 301 and 401 can operate.

The configuration of the processor 71 is substantially the same as that of the processor 11 of FIG. 1, and therefore, a description of the configuration of the processor 71 is omitted herein.

The memory 72 may store one or more of an operating system (OS), various application programs, data, and instructions to provide an environment necessary to perform a method of providing product-related content.

The configuration of the memory 72 is substantially the same as that of the memory 12 of FIG. 2, and therefore, a description of the configuration of the memory 72 is omitted herein.

The communication module 73 may include various types of communication devices that enable the server 201 to transmit/receive data to/from external devices. The server 201 may transmit data based on application programs, data, and/or instructions for operation of the product-related content providing application to the electronic shelf label 101 and/or the computing devices 301 and 401 via the communication module 73.

The location information database 74 may store location information of electronic shelf labels 101. A plurality of electronic shelf labels 101 corresponding to a plurality of products may be provided on the shelf 30. These electronic shelf labels 101 may be placed at specific locations on the shelf 30, and specific location information of the electronic shelf labels 101 with respect to the shelf 30 may be stored in the location information database 74.

The location information database 74 is substantially the same as the location information database 14 of FIG. 1, and therefore, a more detailed description of the location information database 74 is omitted herein.

The LED control module 75 may control lighting of the LED 67 of the electronic shelf label 101 based on an LED lighting signal from the computing devices 301 and 401.

For example, a first LED lighting signal according to a first product selection user input for selecting any first product with respect to the computing device 301 or 401 may be received through the communication module 73 and transmitted to the LED control module 75. The LED control module 75 may control the operation of a first LED of a first electronic shelf label to which the first product is assigned such that the first LED of the first electronic shelf label lights up.

The content database 76 may store content related to the product assigned to the electronic shelf label 101. Here, the product-related content may include advertising content for the product. For example, the product-related content may include videos, animations, images, and detailed product descriptions for promoting the product. However, the present disclosure is not limited thereto, and the product-related content may include various forms of content related to the product other than advertising content.

User input via the buttons 1 and 2 of the electronic shelf label 101 may be transmitted to the server 201 via the communication module 73 of the electronic shelf label 101. Accordingly, the processor 71 of the server 201 may retrieve product-related content corresponding to product-related information displayed on the display module 65 of the electronic shelf label 101 from the content database 76. The product-related content stored in the content database 76 may be edited and stored by a user in advance.

The content database 76 may be included in the server 201, but the present disclosure is not limited thereto, and the content database 76 may be implemented as a separate electronic device external to the server 201.

The product-related information update module 77 may update product-related information displayed on the electronic shelf label 101. For example, the product-related information update module 27 may control the electronic shelf label 101 such that product-related information displayed on the electronic shelf label 101 is periodically updated according to product-related information update rules stored in the memory 72. The product-related information update rules stored in the memory 72 may be preset by the user and constantly modified.

However, the present disclosure is not limited thereto, and the product-related information update module 77 may also control the electronic shelf label 101 such that product-related information displayed on the electronic shelf label 101 is updated according to editing input of the user.

Although the server 201 according to and embodiment has been described as performing the functional operations, various embodiments in which at least some functional operations performed by the server 201 may be performed by an external device (e.g., the electronic shelf label 101 or the computing device 301 or 401), or at least some functional operations performed by the external device may be further performed by the server 201 are possible.

### -Computing Devices 301 and 401

The computing devices 301 and 401 may be devices on which a product-related content providing application is installed. The computing devices 301 and 401 may include portable user terminals.

The computing devices 301 and 401 may be divided into a first user terminal 301 and a second user terminal 401 used by different users. For example, the first user terminal 301 may be used by a customer at a store, and the second user terminal 401 may be used by an on-site employee at the store. The first user terminal 301 and the second user terminal 401 may have substantially the same structure.

The computing devices 301 and 401 may include a display module, through which product-related content can be displayed, and user input for selecting a product may be received during the execution of a product-related content providing application.

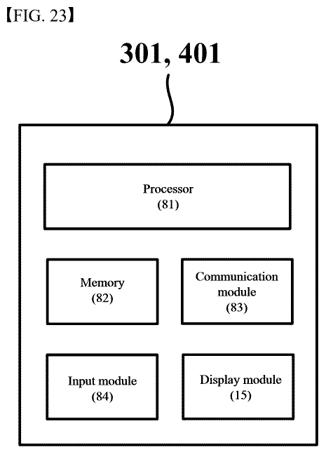

Referring to FIG. 23, the computing devices 301 and 401 may include a processor 81, a memory 82, a communication module 83, an input module 84, and a display module 85. Various components included in the computing devices 301 and 401 may be designed to be incorporated within the housing of the computing devices 301 and 401.

Since the computing devices 301 and 401 are substantially the same as the computing devices 300 and 400 of FIG. 1, a more detailed description of the computing devices 301 and 401 is omitted here.

Meanwhile, the system 2000 may further include an imaging device (not shown) installed around the shelf 30 to capture images of the electronic shelf labels 101 provided on the shelf 30 and the area where products are placed. The imaging device may be movably installed around the shelf 30 to periodically capture images of the electronic shelf label 100 and products on the shelf 30.

For example, in a situation where multiple shelves 30 are arranged, the imaging device may be installed on a first shelf and configured to capture images of electronic shelf labels 101 and products on a second shelf facing the first shelf. User input via the buttons 1 and 2 of the electronic shelf label 101 may be transmitted to the server 201 via the communication module 63. In this case, the processor 71 of the server 201 may control the imaging device based on user input via the buttons 1 and 2.

For example, the processor 71 may acquire a captured image by causing the imaging device to capture the electronic shelf label 101 that has received user input and the area where the product assigned to the electronic shelf label 101 is placed.

The processor 71 may transmit data of the captured image to the electronic shelf label 101 and/or the computing device 301 or 401. The captured image may be displayed on the display module 65 of the electronic shelf label 101 and/or the display module 85 of the computing device 301 or 401 along with product-related content.

The captured image may include information regarding the display status of a product, the number of products, etc. Accordingly, store customers can obtain information regarding the real-time display status of a product as well as content related to the product through information displayed on the display module 65 of the electronic shelf label 101 and/or the display module 85 of the computing devices 301 and 401.

### -Methods S300 and S400 of Providing Product-Related Content

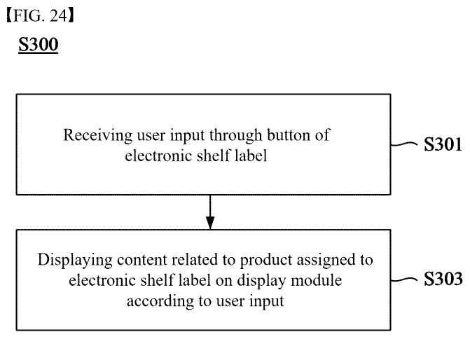

Hereinafter, methods of providing product-related content through a product-related content providing application executed by a processor 61 of the electronic shelf label 101 and/or the processor 81 of the computing devices 301 and 401 according to various embodiments will be described in detail with reference to FIG. 24 to FIG. 30.

In various embodiments, the processor 61 of the electronic shelf label 101 and/or the processor 81 of the computing devices 301 and 401 may execute a product-related content providing application stored in the memories 61 and 82 or operate the same in the background.

Although the processor 61 of the electronic shelf label 101 and/or the processor 81 of the computing devices 301 and 401 operate to execute instructions of the product-related content providing application, thereby providing an environment necessary to perform the above-described product-related content providing method, the product-related content providing application performs the operation instead of the processor 61 of the electronic shelf label 101 and/or the processor 81 of the computing devices 301 and 401 in the following description for convenience of description.

FIG. 24 is a flowchart illustrating a method S300 of providing product-related content according to an embodiment.

Referring to FIG. 24, the method S300 of providing product-related content may include step S301 of receiving user input through the buttons 1 and 2 of the electronic shelf label 101, and step S303 of displaying content related to a product assigned to the electronic shelf label 101 on the display modules 65 and 85 according to the user input.

In step S301 of receiving user input through the buttons 1 and 2 of the electronic shelf label 101, for example, when a store customer or on-site staff presses the first button 1 and/or the second button 2 of the electronic shelf label 101, the processor 61 of the electronic shelf label 101 may receive the user input.

Alternatively, user input via the first button 1 and/or the second button 2 may be transmitted to the server 201 via the communication module 63 of the electronic shelf label 101, and the processor 71 of the server 201 may receive the user input.

The processors 61 and 71 can process product-related content corresponding to product-related information displayed on the display module 65 based on the user input via the buttons 1 and 2.

For example, the processors 61 and 71 that have received the user input via the first button 1 and/or the second button 2 may retrieve content related to the product assigned to the electronic shelf label 101 from the content databases 64 and 76.

For example, the processor 61 of the electronic shelf label 101 may retrieve content related to the product assigned to the electronic shelf label 101 from the content database 64. Furthermore, the processor 71 of the server 201 may transmit data regarding content related to the product assigned to the electronic shelf label 101, retrieved from the content database 76, back to the electronic shelf label 101.

In this way, the process of processing product-related content in step S301 may be performed by the processor 61 of the electronic shelf label 101 or the processor 71 of the server 201.

In step S303 of displaying the content related to the product assigned to the electronic shelf label 101, the processor 61 of the electronic shelf label 101 may control the operation of the display module 65 such that the retrieved product-related content is displayed on the display module 65.

Furthermore, even when the processor 71 of the server 201 has retrieved the product-related content, the processor 61 of the electronic shelf label 101 may control the operation of the display module 65 such that the product-related content is displayed on the display module 65 based on the data regarding the product-related content received from the server 201.

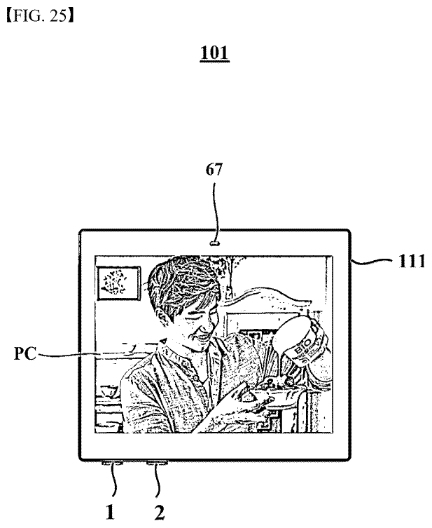

For example, referring to FIG. 25, the processor 61 can control the operation of the display module 65 such that product-related content PC is displayed on the entire front surface of the display module 65 of the electronic shelf label 101. In this case, product-related information PI previously displayed on the display module 65 can be replaced with the product-related content PC, and thus the product-related content PC can be displayed on the entire front surface of the display module 65. Here, the product-related content PC may be a video for promoting the product.

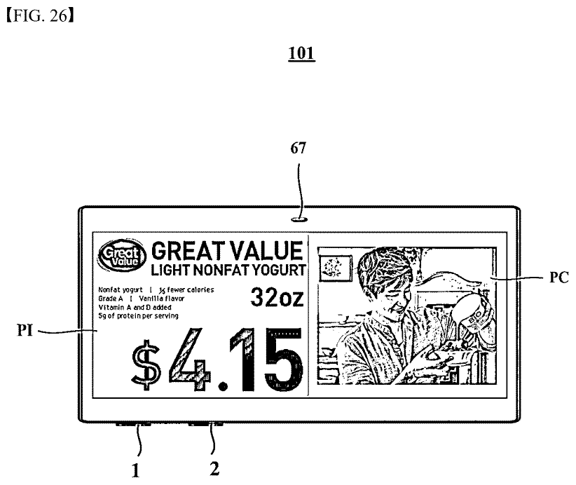

However, the present disclosure is not limited thereto, and referring to FIG. 26, the processor 61 may control the operation of the display module 65 such that product-related content PC is displayed on a portion of the front surface of the display module 65 of the electronic shelf label 101.

In this case, the product-related information PI previously displayed on the display module 65 may be displayed on a portion of the front surface of the display module 65, and the product-related content PC may be displayed on another portion of the front surface of the display module 15.

For example, the product-related information PI may be displayed on the left side of the front surface of the display module 65, and the product-related content PC may be displayed on the right side of the front surface of the display module 65. Here, the product-related content PC may be a video for promoting the product.

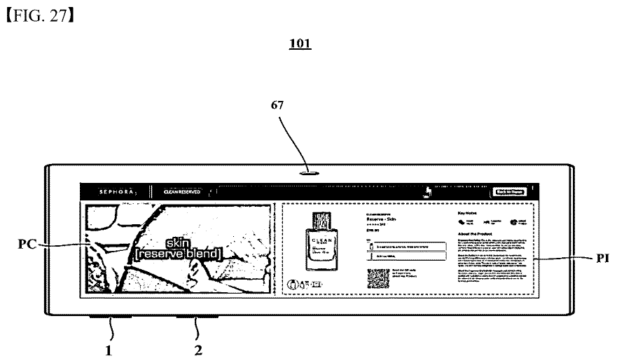

However, the present disclosure is not limited thereto, and referring to FIG. 27, the processor 61 may control the operation of the display module 65 such that product-related information PI may be displayed on the right side of the front surface of the display module 65, and product-related content PC may be displayed on the left side of the front of the display module 65. Here, the product-related content PC may be a video for promoting the product.

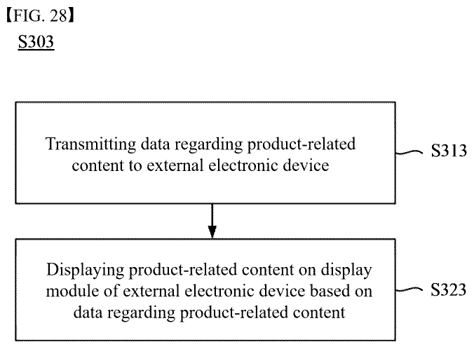

Meanwhile, referring to FIG. 28, step S303 of displaying content related to the product assigned to the electronic shelf label 101 according to another embodiment may include step S313 of transmitting data regarding the content related to the product to an external electronic device, and step S323 of displaying the product-related content on a display module of the external electronic device based on the data of the product-related content.

In step S313 of transmitting data regarding the product-related content to an external electronic device, the processor 61 of the electronic shelf label 101 may transmit data regarding the product-related content to the external electronic device via the communication module 63.

Here, the external electronic device may be a user terminal type computing device 301 or 401. However, the present disclosure is not limited thereto, and the external electronic device may be any electronic device including a display module capable of displaying product-related content. For example, the external electronic device may include a kiosk installed in a fixed manner in a certain area of a store.

In step S323 of displaying the product-related content on a display module of an external electronic device, the processor of the external electronic device may control the operation of the display module to display the product-related content on the display module.

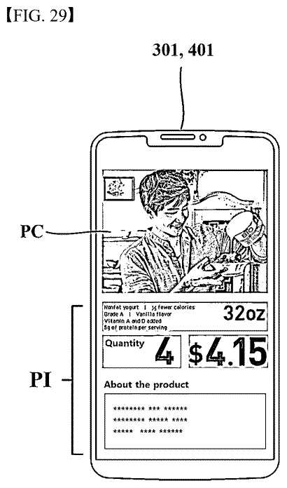

For example, data regarding the product-related content may be transmitted from the electronic shelf label 101 to the user terminal type computing device 301 or 401. In this case, referring to FIG. 29, the processor 81 of the computing device 301 or 401 may control the operation of the display module 85 to display product-related content PC on the front surface of the display module 85. In this case, product-related information PI may be displayed on the display module 85 along with the product-related content PC.

For example, the product-related content PC may be displayed on the upper portion of the front surface of the display module 85, and the product-related information PI may be displayed on the lower portion of the front surface of the display module 85. However, the present disclosure is not limited thereto, and the positions where the product-related content PC and the product-related information PI are displayed on the front surface of the display module 85 can be set in various ways. The product-related information PI may include a product weight, the number of products displayed on the shelf 30, a product price, and detailed product description.

Furthermore, a user interface providing a payment service for the product may be displayed simultaneously with the product-related information PI and the product-related content PC on the display module 85 of the computing device 301 or 401. For example, a payment link for payment for the product may be displayed on the display module 85 of the computing device 301 or 401.

In this way, the product-related content PC may be displayed on the display module 85 of the electronic shelf label 101 or on the display module 85 of the user terminal type computing devices 301 and 401.

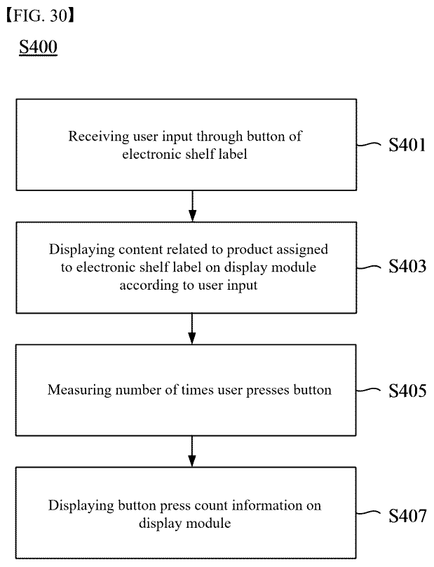

FIG. 30 is a flowchart illustrating a method S400 of providing product-related content according to another embodiment.

Referring to FIG. 30, the method S400 of providing product-related content may include step S401 of receiving user input via the buttons 1 and 2 of the electronic shelf label 100, step S403 of displaying content related to a product assigned to the electronic shelf label 101 based on the user input on the display modules 65 and 85, step S405 of measuring the number of times the user presses the buttons 1 and 2, and step S407 of displaying information on the number of button presses on the display modules 65 and 85.

Steps S401 and S403 included in the method S100 of FIG. 30 are substantially the same as steps S301 and S303 included in the method S300 of FIG. 24, and therefore, a description of steps S401 and S403 will be omitted.

In step S405 of measuring the number of button presses, the button press counter 66 of the electronic shelf label 101 may measure the number of times the user presses the buttons 1 and 2.

For example, when the user presses the second button 2, product-related content may be displayed on the display module 65 of the electronic shelf label 101 or the display module 85 of the computing device 301 or 401. In this case, the button press counter 66 may measure the number of button presses with respect to the second button 2, which causes the product-related content to be displayed on the display modules 65 and 85.

In step S407 of displaying button press count information, data on the number of button presses measured by the button press counter 66 may be transmitted to an external electronic device by the processor 61. For example, the processor 61 may transmit the button press count data to the user terminal type computing device 301 or 401 via the communication module 63.

The processor 81 of the computing device 301 or 401 may control the operation of the display module 85 such that the button press count information is displayed on the display module 85. Store customers or on-site staff can utilize the button press count information displayed on the display module 85 to determine the level of interest in the product among store customers.

The specific implementations described herein are exemplary embodiments and do not limit the scope of the present disclosure in any way. For the sake of brevity, descriptions of conventional electronic components, control systems, software, and other functional aspects of the systems may be omitted. Furthermore, the lines or connecting elements between components depicted in the drawings are merely illustrative of functional connections and/or physical or circuit connections. In actual devices, these connections may be replaced or represented as various additional functional, physical, or circuit connections. Furthermore, unless specifically stated as “essential,” “important,” or the like, a component may not be absolutely necessary for the application of the present disclosure.

Although the detailed description of the present disclosure has been made with reference to preferred embodiments of the present disclosure, it will be understood by those skilled in the art or those with ordinary knowledge in the art that various modifications and variations can be made to the present disclosure without departing from the spirit and scope of the present disclosure as set forth in the claims. Therefore, the technical scope of the present disclosure should not be limited to the details set forth in the detailed description of the specification, but should be defined by the scope of the claims.

### INDUSTRIAL APPLICABILITY

The present disclosure provides an electronic shelf label that has improved waterproofing properties by applying a sealing member of a specific structure, maximizes internal space utilization, resulting in enhanced durability and a slim design, and has a window covering a display module and covering the entire front surface of the main case to enhance structural integrity and esthetics, thereby improving the manageability of countless electronic shelf labels displayed in stores, resulting in industrial applicability.

The present disclosure also has industrial applicability in that the present disclosure enables content of information related to a product assigned to an electronic shelf label to be displayed on a display such as a user terminal or a fixed kiosk by operating a button included in the electronic shelf label, allowing users to easily obtain product-related information, thereby aiding in product purchasing decisions and, consequently, increasing sales.

1. An electronic shelf label comprising:
a window;
a main case coupled to a rear surface of the window;
a display module provided in a first internal space formed between the rear surface of the window and the main case to display product information;
a printed circuit board provided in the first internal space and electrically connected to the display module;
a rear cover coupled to a rear surface of the main case;
a battery provided in a second internal space formed between the main case and the rear cover; and
a sealing member provided on a side surface of the rear cover.

2. The electronic shelf label of claim 1, wherein the rear cover includes a protrusion coupled to the main case, and the sealing member is provided on an outer side surface of the protrusion.

3. The electronic shelf label of claim 2, wherein a sealing groove is formed on an outer side surface of the protrusion of the rear cover, and the sealing member is provided in the sealing groove.

4. The electronic shelf label of claim 1, wherein the sealing member has a closed loop shape surrounding the side surface of the rear cover.

5. The electronic shelf label of claim 1, wherein the sealing member contacts an inner surface of the main case.

6. The electronic shelf label of claim 2, wherein an end of the protrusion of the rear cover has a hook shape, and the hook-shaped end faces the battery.

7. The electronic shelf label of claim 1, wherein the main case comprises:
a flat plate;
a first protrusion protruding upward from an edge region of an upper surface of the plate; and
a second protrusion protruding downward from an edge region of a lower surface of the plate.

8. The electronic shelf label of claim 7, wherein the first protrusion contacts an edge region of a lower surface of the window.

9. The electronic shelf label of claim 7, wherein the rear cover is provided to be surrounded by an inner surface of the second protrusion.

10. The electronic shelf label of claim 9, wherein the rear cover comprises a third protrusion surrounded by the second protrusion and coupled to the main case.

11. The electronic shelf label of claim 10, wherein a first sub-protrusion is formed on an inner surface of the second protrusion, and a second sub-protrusion supported by the first sub-protrusion is formed on an outer side surface of the third protrusion.

12. The electronic shelf label of claim 10, wherein a fourth protrusion is formed to protrude downward in a portion of the plate,
wherein an end of the third protrusion has a first hook shape, and an end of the fourth protrusion has a second hook shape formed to engage with the first hook shape.

13. The electronic shelf label of claim 7, wherein the lower surface of the rear cover and the lower surface of the second protrusion are disposed on the same line.

14. The electronic shelf label of claim 1, wherein a step is formed on an edge region of an upper surface of the main case, and the bonding member is provided on the step.

15. The electronic shelf label of claim 1, wherein the window covers the entire front surface of the main case.
